(19) United States
(12) Patent Application Publication
(10) Pub. No.: US 2025/0007677 A1
(43) Pub. Date: Jan. 2, 2025

(54) UNIFIED TRANSMISSION CONFIGURATION INDICATOR INDICATION FOR SINGLE DOWNLINK CONTROL INFORMATION BASED MULTIPLE TRANSMIT RECEIVE POINT COMMUNICATIONS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/709,988

(22) PCT Filed: Jan. 24, 2022
(86) PCT No.: PCT/CN2022/073405

§ 371 Date: May 14, 2024

(51) Int. Cl. H04L 5/00; H04W 72/044; H04W 72/232

(52) U.S. Cl. CPC H04L 5/0094; H04L 5/0053; H04W 72/044; H04W 72/232

(57) ABSTRACT

Various aspects of the present disclosure generally relate to wireless communication. In some aspects, a user equipment (UE) may receive configuration information associated with a single downlink control information (DCI) multiple transmit receive point (TRP) mode, wherein the configuration information indicates at least one of respective repetition modes for one or more physical channels or a list of configured reference signals. The UE may receive an indication of a pair of unified transmission configuration indicators (TCIs). The UE may communicate with at least one of a first TRP or a second TRP using beam directions associated with the pair of unified TCIs based at least in part on the configuration information. Numerous other aspects are described.

### FIELD OF THE DISCLOSURE

Aspects of the present disclosure generally relate to wireless communication and to techniques and apparatuses for unified transmission configuration indicator (TCI) indication for single downlink control information (DCI) based multiple transmit receive point (TRP) communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive configuration information associated with a single downlink control information (DCI) multiple transmit receive point (TRP) mode, wherein the configuration information indicates at least one of respective repetition modes for one or more physical channels or a list of configured reference signals. The one or more processors may be configured to receive an indication of a pair of unified transmission configuration indicators (TCIs). The one or more processors may be configured to communicate with at least one of a first TRP or a second TRP using beam directions associated with the pair of unified TCIs based at least in part on the configuration information.

Some aspects described herein relate to a base station for wireless communication. The base station may include a memory and one or more processors coupled to the memory. The one or more processors may be configured to transmit, to a UE, configuration information associated with a single DCI multiple-TRP mode, wherein the configuration information indicates at least one of respective repetition modes for one or more physical channels or a list of configured reference signals. The one or more processors may be configured to transmit, to the UE, an indication of a pair of unified TCIs. The one or more processors may be configured to communicate with the UE using at least one of a first beam direction associated with a first unified TCI of the pair of TCIs or a second beam direction associated with a second unified TCI of the pair of unified TCIs.

Some aspects described herein relate to a method of wireless communication performed by a UE. The method may include receiving configuration information associated with a single DCI multiple-TRP mode, wherein the configuration information indicates at least one of respective repetition modes for one or more physical channels or a list of configured reference signals. The method may include receiving an indication of a pair of unified TCIs. The method may include communicating with at least one of a first TRP or a second TRP using beam directions associated with the pair of unified TCIs based at least in part on the configuration information.

Some aspects described herein relate to a method of wireless communication performed by a base station. The method may include transmitting, to a UE, configuration information associated with a single DCI multiple-TRP mode, wherein the configuration information indicates at least one of respective repetition modes for one or more physical channels or a list of configured reference signals. The method may include transmitting, to the UE, an indication of a pair of unified TCIs. The method may include communicating with the UE using at least one of a first beam direction associated with a first unified TCI of the pair of TCs or a second beam direction associated with a second unified TCI of the pair of unified TCIs.

Some aspects described herein relate to a non-transitory computer-readable medium that stores a set of instructions for wireless communication by a UE. The set of instructions, when executed by one or more processors of the UE, may cause the UE to receive configuration information associated with a single DCI multiple-TRP mode, wherein the configuration information indicates at least one of respective repetition modes for one or more physical channels or a list of configured reference signals. The set of instructions, when executed by one or more processors of the UE, may cause the UE to receive an indication of a pair of unified TCIs. The set of instructions, when executed by one or more processors of the UE, may cause the UE to communicate with at least one of a first TRP or a second TRP using beam directions associated with the pair of unified TCIs based at least in part on the configuration information.

Some aspects described herein relate to a non-transitory computer-readable medium that stores a set of instructions for wireless communication by a base station. The set of instructions, when executed by one or more processors of the base station, may cause the base station to transmit, to a UE, configuration information associated with a single DCI multiple-TRP mode, wherein the configuration information indicates at least one of respective repetition modes for one or more physical channels or a list of configured reference signals. The set of instructions, when executed by one or more processors of the base station, may cause the base station to transmit, to the UE, an indication of a pair of unified TCIs. The set of instructions, when executed by one or more processors of the base station, may cause the base station to communicate with the UE using at least one of a first beam direction associated with a first unified TCI of the pair of TCs or a second beam direction associated with a second unified TCI of the pair of unified TCIs.

Some aspects described herein relate to an apparatus for wireless communication. The apparatus may include means for receiving configuration information associated with a single DCI multiple-TRP mode, wherein the configuration information indicates at least one of respective repetition modes for one or more physical channels or a list of configured reference signals. The apparatus may include means for receiving an indication of a pair of unified TCIs. The apparatus may include means for communicating with at least one of a first TRP or a second TRP using beam directions associated with the pair of unified TCIs based at least in part on the configuration information.

Some aspects described herein relate to an apparatus for wireless communication. The apparatus may include means for transmitting, to a UE, configuration information associated with a single DCI multiple-TRP mode, wherein the configuration information indicates at least one of respective repetition modes for one or more physical channels or a list of configured reference signals. The apparatus may include means for transmitting, to the UE, an indication of a pair of unified TCIs. The apparatus may include means for communicating with the UE using at least one of a first beam direction associated with a first unified TCI of the pair of TCs or a second beam direction associated with a second unified TCI of the pair of unified TCIs.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of using beams for communications between a base station and a UE, in accordance with the present disclosure.

FIG. 4 is a diagram illustrating an example logical architecture of a distributed radio access network (RAN), in accordance with the present disclosure.

FIG. 5 is a diagram illustrating an example of multiple transmit receive point (TRP) communication, in accordance with the present disclosure.

FIG. 6 is a diagram illustrating an example associated with single frequency network (SFN) physical downlink control channel (PDCCH) transmission, in accordance with the present disclosure.

FIGS. 7-11 are diagrams illustrating examples associated with unified transmission configuration indicator (TCI) indication for single downlink control information (DCI) based multiple-TRP communications, in accordance with the present disclosure.

FIGS. 12-13 are diagrams illustrating example processes associated with unified TCI indication for single DCI based multiple-TRP communications, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

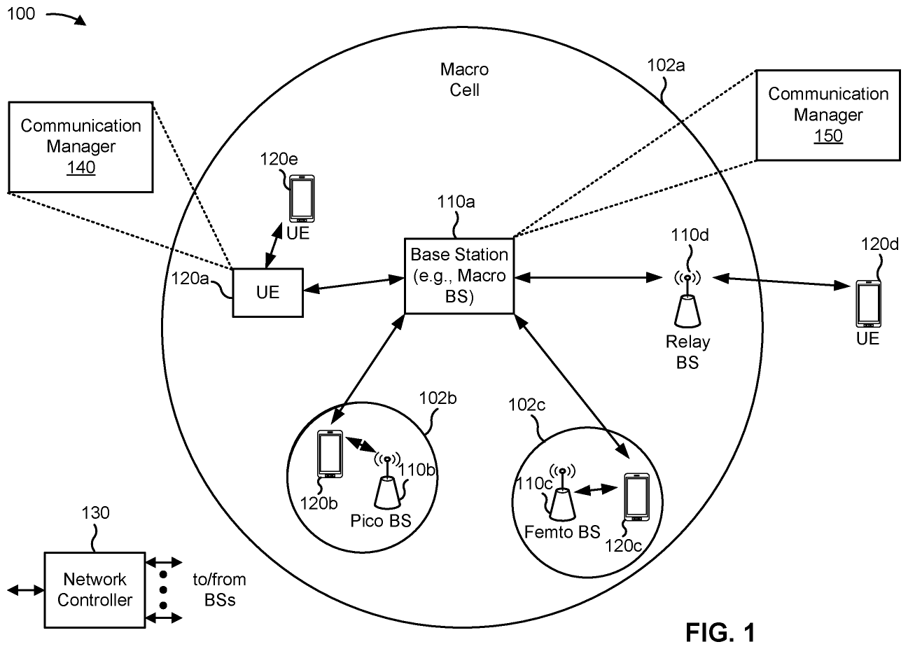

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a next generation Node B (gNB) (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information associated with a single downlink control information (DCI) multiple-TRP mode, wherein the configuration information indicates at least one of respective repetition modes for one or more physical channels or a list of configured reference signals; receive an indication of a pair of unified transmission configuration indicators (TCIs); and communicate with at least one of a first TRP or a second TRP using beam directions associated with the pair of unified TCIs based at least in part on the configuration information. Additionally, or alternatively, the communication manager 140 may perform one or more other operations described herein.

In some aspects, the base station 110 may include a communication manager 150. As described in more detail elsewhere herein, the communication manager 150 may transmit, to a UE, configuration information associated with a single DCI multiple-TRP mode, wherein the configuration information indicates at least one of respective repetition modes for one or more physical channels or a list of configured reference signals; transmit, to the UE, an indication of a pair of unified TCIs; and communicate with the UE using at least one of a first beam direction associated with a first unified TCI of the pair of TCIs or a second beam direction associated with a second unified TCI of the pair of unified TCIs. Additionally, or alternatively, the communication manager 150 may perform one or more other operations described herein.

As indicated above, FIG. 1 is provided as an example. Other examples may differ from what is described with regard to FIG. 1.

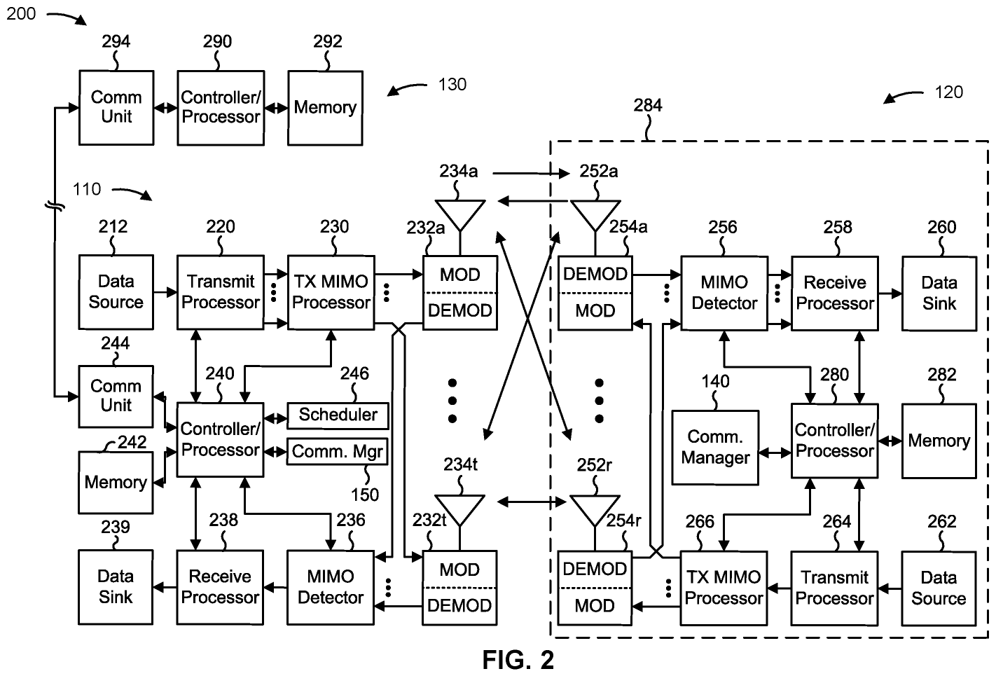

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

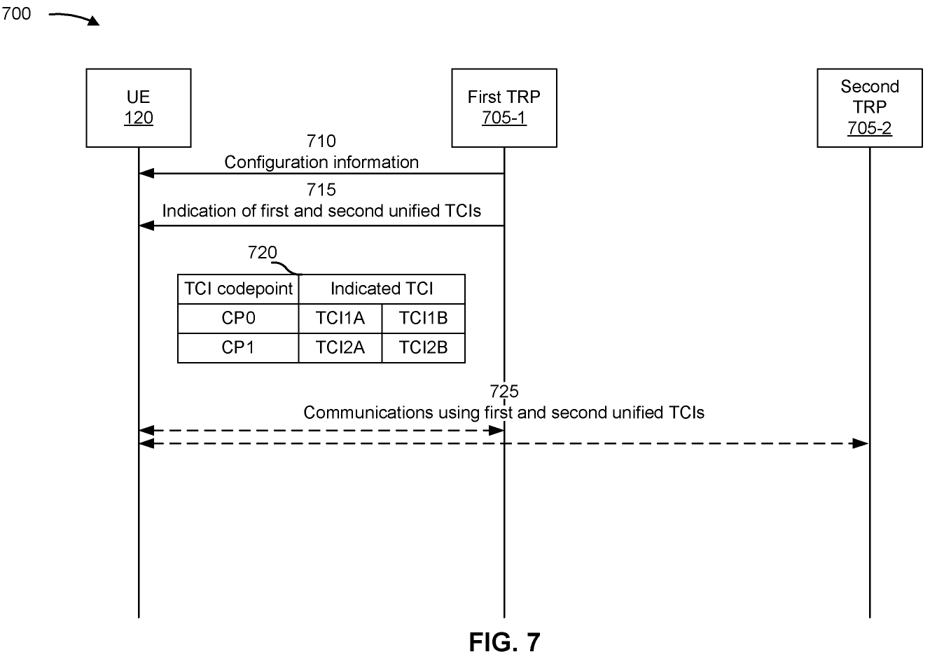

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-15).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-15).

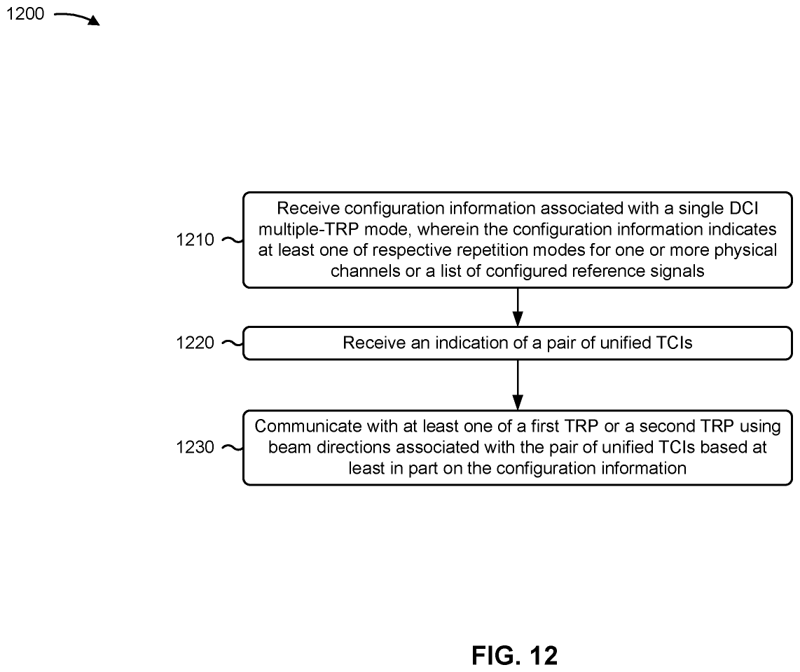

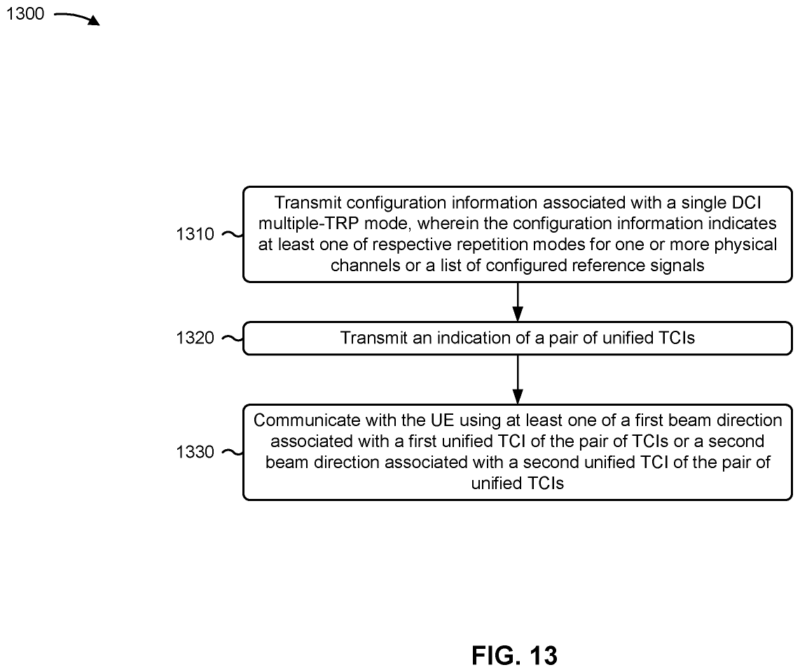

The controller/processor 240 of the base station 110, the controller/processor 280 of the UE 120, and/or any other component(s) of FIG. 2 may perform one or more techniques associated with unified TCI indication for single DCI based multiple-TRP communications, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples. In some aspects, the TRP described herein is the base station 110, is included in the base station 110, or includes one or more components of the base station 110 shown in FIG. 2

In some aspects, the UE 120 includes means for receiving configuration information associated with a single DCI multiple-TRP mode, wherein the configuration information indicates at least one of respective repetition modes for one or more physical channels or a list of configured reference signals; means for receiving an indication of a pair of unified TCIs; and/or means for communicating with at least one of a first TRP or a second TRP using beam directions associated with the pair of unified TCIs based at least in part on the configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, configuration information associated with a single DCI multiple-TRP mode, wherein the configuration information indicates at least one of respective repetition modes for one or more physical channels or a list of configured reference signals; means for transmitting, to the UE, an indication of a pair of unified TCIs; and/or means for communicating with the UE using at least one of a first beam direction associated with a first unified TCI of the pair of TCIs or a second beam direction associated with a second unified TCI of the pair of unified TCIs. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

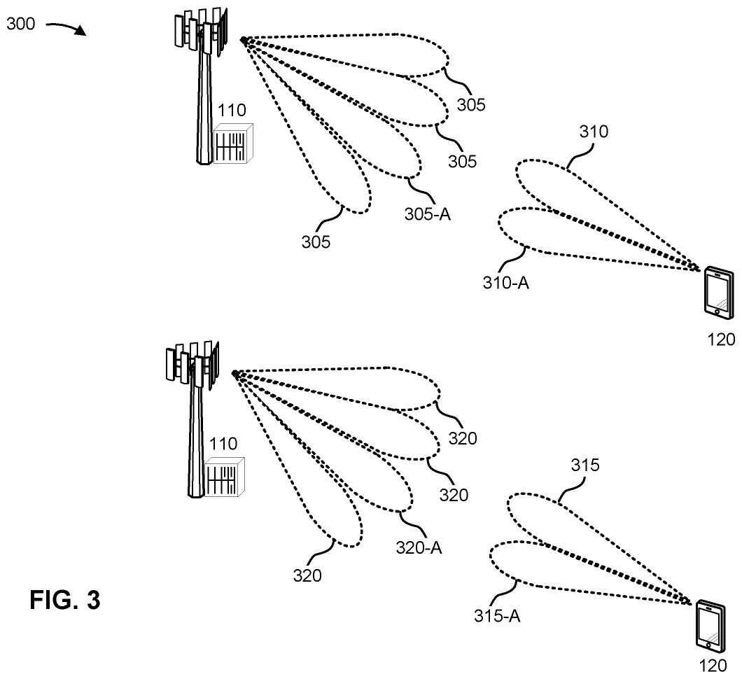

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may identify a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 315-A and the BS receive beam 320-A), which may be further refined and maintained in accordance with one or more established beam refinement procedures. In some examples, an uplink beam, such as a UE transmit beam 315 or a BS receive beam 320, may be associated with a spatial relation. A spatial relation may indicate a directionality or a characteristic of the uplink beam, similar to one or more QCL properties, as described above.

As described above in some examples, a TCI state may be used for a downlink beam indication and a spatial relation may be used for an uplink beam indication. Such beam indications may be referred to herein as “non-unified beam indications.” Non-unified beam indications may be applied to one channel for one communication scheduled in that channel.

In some examples, the base station 110 and the UE 120 may use a unified TCI state framework for both downlink and uplink beam indications. In the unified TCI state framework, TCI state indications may be used to indicate a joint downlink and uplink TCI state or to indicate separate downlink and uplink TCI states. Such a TCI state indication that may be used to indicate a joint downlink and uplink beam, a separate downlink beam, or a separate uplink beam is referred to herein as a “unified TCI state indication.” A unified TCI state indication (e.g., a joint downlink and uplink TCI state indication and/or separate downlink and uplink TCI state indications) may be applied to multiple channels. For example, the unified TCI state indication of a joint uplink and downlink TCI state may be used to indicate a beam direction for one or more downlink channels (e.g., PDSCH and/or PDCCH) or reference signals (e.g., CSI-RS) and for one or more uplink channels (e.g., a physical uplink shared channel (PUSCH) and/or a physical uplink control channel (PUCCH)) or reference signals (e.g., a sounding reference signal (SRS)). The unified TCI state indication of a separate downlink TCI state may be used to indicate a beam direction for multiple downlink channels (e.g., PDSCH and PDCCH) or reference signals (e.g., CSI-RS). The unified TCI state indication of a separate uplink TCI state may be used to indicate a beam direction to be used for multiple uplink channels (e.g., PUSCH and PUCCH) or reference signals (e.g., SRS). In some examples, the unified TCI state indication may be “sticky,” such that the indicated beam direction will be used for the channels and/or reference signals to which the TCI state indication applies until a further indication is received.

In some examples, there may be two TCI state indication modes in the unified TCI state framework. A first mode may be a separate downlink and uplink TCI state indication mode, in which separate downlink and uplink TCI states are used to indicate downlink and uplink beam directions for the UE 120. For example, the separate downlink and uplink TCI state indication mode may be used when the UE 120 is having maximum permissible exposure (MPE) issues to indicate different beam directions, for the UE 120, for an uplink beam (e.g., a UE transmit beam 315) and a downlink beam (e.g., a UE receive beam 310). A second mode may be a joint downlink and uplink TCI state indication mode, in which a TCI state indication is used to indicate, to the UE 120, a joint uplink and downlink beam direction. For example, the joint downlink and uplink TCI state indication mode may be used when the UE 120 has channel correspondence between downlink and uplink channels (which may be assumed in some examples), and the same beam direction can be used for an uplink beam (e.g., a UE transmit beam 315) and a downlink beam (e.g., a UE receive beam 315).

As indicated above, FIG. 3 is provided as an example. Other examples may differ from what is described with respect to FIG. 3.

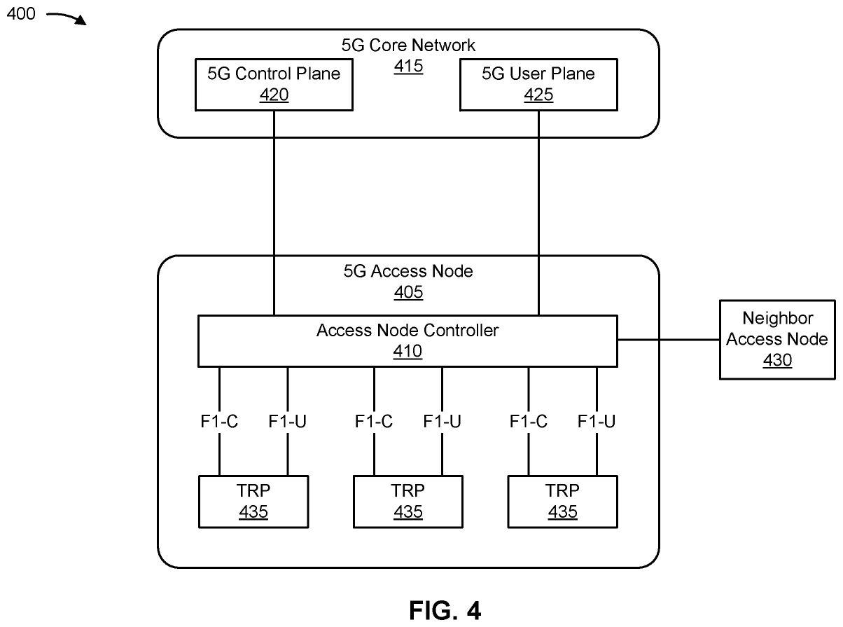

FIG. 4 is a diagram illustrating an example logical architecture of a distributed radio access network (RAN) 400, in accordance with the present disclosure.

A 5G access node 405 may include an access node controller 410. The access node controller 410 may be a central unit (CU) of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a distributed unit (DU) of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a packet data convergence protocol (PDCP) layer, a radio link control (RLC) layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

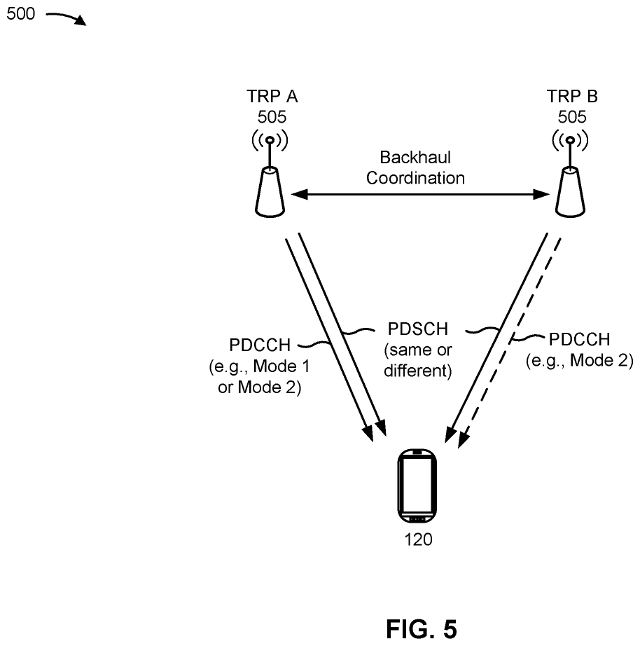

FIG. 5 is a diagram illustrating an example 500 of multiple-TRP (multi-TRP) communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single PDCCH may be used to schedule downlink data communications for a single PDSCH. In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some examples, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1). In some examples, a single TCI codepoint (e.g., in the TCI field in the DCI) may be associated with two TCI states (e.g., the first TCI state associated with the first TRP 505 and the second TCI state associated with the second TRP 505). In this case, a single indication in the TCI field may be used to indicate two TCI states for multiple-TRP transmission of the PDSCH. The first multi-TRP transmission mode (e.g., Mode 1) may be referred to as a single DCI multiple-TRP mode.

In some aspects, multiple-TRP transmission of the PDSCH may be configured for PDSCH repetitions. For example, transmissions of the PDSCH from the first TRP 505 using the first QCL relationship indicated by the first TCI state, and transmissions of the PDSCH from the second TRP 505 using the second QCL relationship indicated by the second TCI state, may be transmitted using space division multiplexing (SDM), frequency division multiplexing (FDM), and/or time division multiplexing (TDM) (e.g., with slot or mini-slot based repetitions). In some aspects, single frequency network (SFN) based multiple-TRP transmission of the PDSCH may be configured. In this case, the first and second TRPs 505 may simultaneously transmit the PDSCH using the same time and frequency resources.

In some aspects, PDCCH repetition may be configured for the UE 120 in the single DCI multiple-TRP mode. In some examples, repetitions of the PDCCH including the DCI may be transmitted in different CORESETs. In this case, the UE 120 may monitor a first search space associated with a first CORESET for an initial PDCCH transmission, and the UE 120 may monitor a second search space associated with a second CORESET for a repetition of the PDCCH transmission. The first and second CORESETs may be associated with the same TRP (e.g., the first TRP 505) or may be associated with different TRPs. In some aspects, SFN based PDCCH transmission may be configured. In this case, the first and second TRPs 505 may simultaneously transmit the PDCCH to the UE 120 using the same time and frequency resources, and the CORESET may have two activated TCI states.

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 11) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state). The second multi-TRP transmission mode (e.g., Mode 2) may be referred to as a multiple DCI multiple-TRP mode.

As indicated above, FIG. 5 is provided as an example. Other examples may differ from what is described with respect to FIG. 5.

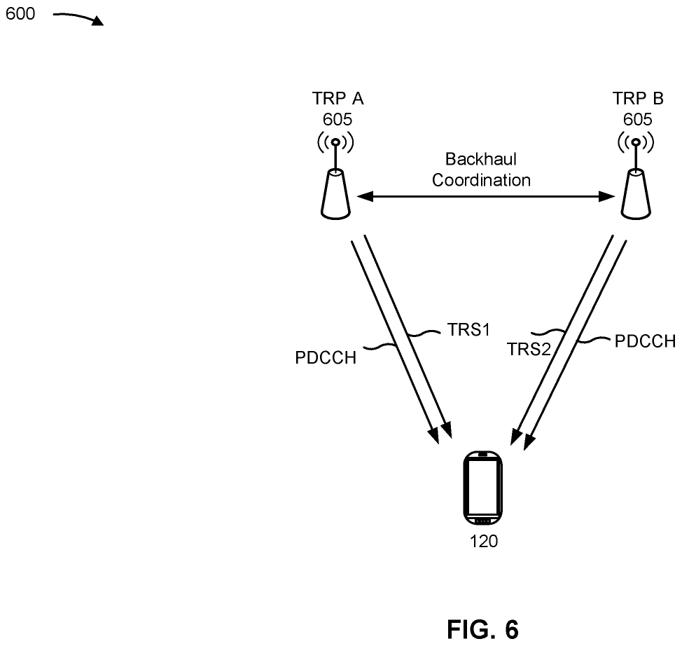

FIG. 6 is a diagram illustrating an example 600 associated with SFN PDCCH transmission, in accordance with the present disclosure. As shown in FIG. 6, multiple TRPs 605 (shown as TRP A and TRP B) may communicate with the same UE 120. A TRP 605 may correspond to a TRP 435 described above in connection with FIG. 4 and/or a TRP 505 described above in connection with FIG. 5.

In some aspects, the UE 120 may be configured in an SFN mode for PDCCH transmission. An SFN mode refers to a mode in which the multiple TRPs 605 transmit to the UE 120 using the same time and frequency resources. As shown in FIG. 6, a first TRP 605 (e.g., TRP A) and a second TRP 605 (e.g., TRP B) may simultaneously transmit the same PDCCH communication (e.g., including the same DCI) to the UE 120 using the same time and frequency resources. This may improve the reliability of the PDCCH, especially in cases of a UE 120 with high mobility or a blockage between the UE 120 and a TRP, among other examples. In some aspects, a CORESET configured for the UE 120 may be configured (e.g., via an RRC configuration) with a higher layer parameter that indicates that the DCI/PDCCH received on the CORESET is transmitted using SFN. The UE 120 may receive (e.g., from one of the TRPs 605) a MAC control element (MAC-CE) activation command that indicates two TCI states (e.g., a first TCI state associated with the first TRP 605 and a second TCI state associated with the second TRP 605) to be activated for the CORESET.

In some aspects, tracking reference signals (TRSs) may be used as source reference signals for the TCI states. For example, the first TCI state may indicate a first QCL relationship with a first TRS (TRS1) transmitted from the first TRP 605 to the UE 120, and the second TCI state may indicate a second QCL relationship with a second TRS (TRS2) transmitted from the second TRP 605 to the UE 120.

In some examples, SFN transmission may be configured for multiple-TRP PDCCH transmission and/or for multiple-TRP PDSCH transmission. In some cases, the PDCCH transmission mode may not be the same as the PDSCH transmission mode. For example, SFN transmission may be configured for one of PDCCH or PDSCH, and repetition without SFN transmission may be configured for the other one of PDCCH or PDSCH.

As indicated above, FIG. 6 is provided as an example. Other examples may differ from what is described with respect to FIG. 6.

As described above, a unified TCI state indication may be used to indicate a joint downlink and uplink beam, a separate downlink beam, and/or a separate uplink beam. However, using unified TCI state indications to provide beam indications for multiple-TRP communications is not straightforward and may result in confusion for a UE as to which beams to use. For example, a unified TCI state indication for a downlink beam (e.g., a joint downlink and uplink TCI state indication or a separate downlink TCI state indication) may be used for PDSCH and for PDCCH in a single-TRP case. However, in a single DCI multiple-TRP case, a unified TCI state indication may indicate downlink beams (e.g., a first TCI state and a second TCI state) for the PDSCH transmissions from two TRPs, but the UE may not know which downlink beam to use for the single PDCCH transmission. Furthermore, some channels (e.g., PDCCH) and reference signals may not be explicitly associated with a TRP. In a multiple-TRP case, a UE may not know how to determine PDSCH and PUCCH beams for a joint uplink and downlink TCI state indication. In addition, the UE may not know, from a unified TCI state indication, which beam(s) to use for PDCCH and/or PUCCH repetitions. As a result, reliability may be decreased, and latency may be increased, for multiple-TRP communications for a UE.

Some techniques and apparatuses described herein enable a UE to receive configuration information associated with a single DCI multiple-TRP mode. The configuration information may indicate respective repetition modes for one or more physical channels and/or a list of configured reference signals. The UE may receive an indication of a pair of unified TCIs, and the UE may communicate with at least one of a first TRP or a second TRP using beam directions associated with the pair of unified TCIs based at least in part on the configuration information. As a result, the UE may determine which beams to use for receiving and/or transmitting communications and/or reference signals in the single DCI multiple-TRP mode. This may result in increased reliability and decreased latency for multiple-TRP communications for the UE.

FIG. 7 is a diagram illustrating an example 700 associated with unified TCI indication for single DCI based multiple-TRP communications, in accordance with the present disclosure. As shown in FIG. 7, example 700 includes communication between a UE 120, a first TRP 705-1, and a second TRP 705-2. In some aspects, the first TRP 705-1, the second TRP 705-2, and UE 120 may be included in a wireless network, such as wireless network 100. The UE 120 may communicate with the first TRP 705-1 and the second TRP 705-2 via wireless access links, which may include uplinks and downlinks.

The first TRP 705-1 and the second TRP 705-2 (collectively, TRPs 705) may correspond to TRPs described elsewhere herein, such as TRPs 435 described above in connection with FIG. 4, TRPs 505 described above in connection with FIG. 5, and/or TRPs 605 described above in connection with FIG. 6. The TRPs 705 may communicate with each other and may coordinate communications with the UE 120 via an interface between the TRPs 705 (e.g., a backhaul interface and/or an access node controller). In some aspects, the TRPs 705 may be in the same cell. For example, the TRPs 705 may be DUs associated with the same 5G access node (e.g., gNB). In some aspects, the TRPs 705 may be co-located at the same base station 110. For example, the TRPs 705 may be different antenna arrays or panels of the same base station 110. In some aspects, the TRPs 705 may be located at different base stations 110.

As shown in FIG. 7, and by reference number 710, the UE 120 may receive configuration information transmitted from a base station 110 (e.g., transmitted from the first TRP 705-1). In some aspects, the base station 110 (e.g., the first TRP 705-1) may transmit the configuration information to the UE 120 in an RRC message. In some aspects, the configuration information may include information that identifies (or may be used to identify) whether the UE 120 is in a multiple-TRP mode (e.g., the UE 120 is being served by multiple TRPs 705) or in a single-TRP mode (e.g., the UE 120 is being served by a single TRP 705). In a case in which the UE 120 is in the multiple-TRP mode, the configuration information may include information that identifies whether the UE 120 is in a single DCI multiple-TRP mode or a multiple DCI multiple-TRP mode. In some aspects, the configuration information may indicate that the UE 120 is in the single DCI multiple-TRP mode.

In some aspects, the configuration information may indicate respective repetition modes for one or more physical channels. For example, the configuration information may include a channel list configuration that indicates respective configurations for the UE 120 for each of the one or more physical channels, and the respective configuration for each physical channel may indicate a respective repetition mode for that physical channel. In some aspects, the configuration information may indicate respective repetition modes for PDCCH, PDSCH, PUCCH, and/or PUSCH. For example, for each channel (e.g., PDCCH, PDSCH, PUCCH, and/or PUSCH) the configuration information may indicate whether the UE 120 is configured for repetitions of communications on that channel or for SFN communications on that channel. For each channel (e.g., PDCCH, PDSCH, PUCCH, and/or PUSCH), the repetitions may be based on time division multiplexing (TDM), frequency division multiplexing (FDM), or spatial division multiplexing (SDM), where each repetition may be associated with a beam.

In some aspects, the configuration information may include a CORESET configuration for the UE 120. In a case in which a PDCCH repetition mode is configured for the UE 120, the configuration information may identify multiple (e.g., 2) lists of CORESETs for the UE 120. For example, the configuration information may identify a first CORESET list (e.g., a first list of CORESETs configured for the UE 120) and a second CORESET list (e.g., a second list of CORESETs configured for the UE 120). The first list of CORESETs may be a list of CORESETs for which the UE 120 is configured to apply a first unified TCI in a pair of unified TCIs indicated in the single DCI multiple-TRP mode. The second list of CORESETs may be a list of CORESETs for which the UE 120 is configured to apply a second unified TCI in the pair of unified TCIs indicated in the single DCI multiple-TRP mode. In some aspects, the first list of CORESETs may be CORESETs which may be used for a first transmission of a PDCCH communication to the UE 120, and the second list of CORESETs may be CORESETs which may be used for a second transmission (e.g., a repetition) of the PDCCH communication to the UE 120. In some aspects, the configuration information may include linking two CORESETs for PDCCH repetitions among multiple CORESETs. The UE 120 may determine two lists of CORESETs, where the first list includes a CORESET (e.g., of lower ID) in two linked CORESETs and the second list includes the other CORESET (e.g., of higher ID) in two linked CORESETs, and may apply the apply a first unified TCI in a pair of unified TCIs indicated to receive the first list of CORESETs, and apply the apply a second unified TCI in a pair of unified TCIs indicated to receive the second list of CORESETs. For any CORESET not linked with any other CORESETs, the UE 120 may determine such CORESETs belongs to one predetermined list, such as the first list.

In some aspects, in a case in which an SFN PDCCH mode is configured for the UE 120, the configuration information may include a list of CORESETs that are configured for SFN PDCCH transmission. For example, for each CORESET in the list of CORESETs that are configured for SFN PDCCH transmission, the configuration information may include a parameter that indicates that the DCI/PDCCH received on the CORESET is transmitted via SFN transmission (e.g., from both TRPs 705).

In some aspects, in a case in which a PDSCH repetition mode, a PUSCH repetition mode, or a PUCCH repetition mode is configured for the UE 120, the configuration information may indicate whether the repetition mode for the channel (e.g., PDSCH, PUSCH, or PUCCH) is an inter-slot TDM repetition mode, an intra-slot TDM repetition mode, an FDM repetition mode, or and an SDM repetition mode. The repetition pattern for inter-slot TDM repetition mode or an intra-slot TDM repetition mode of PDSCH, PUSCH or PUCCH may be cyclic or sequential, where the cyclic pattern is ABAB and the sequential pattern is AABB, with A in the first set of repetitions and B in the second set of repetitions.

In some aspects, the configuration information may indicate configurations for uplink and/or downlink reference signals. For example, the configuration information may include configured lists of CSI-RSs or CSI-RS sets for the UE 120 and/or configured lists of SRSs or SRS sets for the UE 120. In some aspects, the configuration information may include a first list of CSI-RSs or CSI-RS sets and a second list of CSI-RSs or CSI-RS sets. The first list of CSI-RSs or CSI-RS sets may be a list of CSI-RSs or CSI-RS sets for which the UE 120 is to apply a first unified TCI in a pair of unified TCIs indicated in the single DCI multiple-TRP mode. The second list of CSI-RSs or CSI-RS sets may be a list of CSI-RSs or CSI-RS sets for which the UE 120 is configured to apply a second unified TCI in the pair of unified TCIs indicated in the single DCI multiple-TRP mode. In some aspects, the second list of CSI-RSs or CSI-RS sets may repeat the CSI-RSs or CSI-RS sets in the first list of CSI-RSs or CSI-RS sets. In some aspects, the configuration information may include a first list of SRSs or SRS sets and a second list of SRSs or SRS sets. The first list of SRSs or SRS sets may be a list of SRSs or SRS sets for which the UE 120 is to apply a first unified TCI indication in a pair of unified TCI indications received in the single DCI multiple-TRP mode. The second list of SRSs or SRS sets may be a list of SRSs or SRS sets for which the UE 120 is configured to apply a second unified TCI indication in the pair of unified TCI indications received in the single DCI multiple-TRP mode. In some aspects, the second list of SRSs or SRS sets may repeat the SRSs or SRS sets in the first list of SRSs or SRS sets.

In some aspects, the configuration information may include a configuration of a TCI state pool for the UE 120. In some aspects, the configuration information may configure a set of TCI codepoints. In this case, the configuration information may include a mapping of each TCI codepoint in the set of TCI codepoints to multiple unified TCIs. For example, each TCI codepoint may indicate (e.g., map to) a respective pair of unified TCIs (e.g., a first unified TCI and a second unified TCI). Each unified TCI may indicate a joint uplink and downlink TCI state that may be used to indicate a beam direction for one or more downlink channels (or downlink reference signals) and for one or more uplink channels (or uplink reference signals), a separate downlink TCI state that may be used to indicate a beam direction for multiple downlink channels (or downlink reference signals), or a separate uplink TCI state that may be used to indicate a beam direction to be used for multiple uplink channels (or uplink reference signals).

As further shown in FIG. 7, and by reference number 715, the UE 120 may receive, from a base station 110 (e.g., from the first TRP 705-1), an indication of a pair of unified TCIs. For example, the indication of the pair of unified TCIs may indicate a first unified TCI and a second unified TCI. In some aspects, the indication of the pair of unified TCIs may be included in DCI transmitted from the base station 110 (e.g., the first TRP 705-1) to the UE 120. For example, the indication of the pair of unified TCIs may be included in DCI scheduling a downlink or uplink communication. In some aspects, the indication of the pair of unified TCIs may be included in a MAC-CE transmitted from the base station 110 (e.g., the first TRP 705-1) to the UE 120. For example, the base station 110 may transmit, to the UE 120, a MAC-CE that activates a pair of unified TCIs (e.g., for one or more CORESETs for receiving PDCCH) from the TCI state pool configured in the configuration information.

As shown by reference number 720, the indication of the pair of unified TCIs may be a TCI codepoint that indicates a first unified TCI and a second unified TCI. For example, the UE 120 may receive the TCI codepoint in DCI or a MAC-CE transmitted from the base station (e.g., the first TRP 705-1). The UE 120 may determine the first unified TCI and the second unified TCI indicated by the TCI codepoint based at least in part on the mapping included in the configuration information. For example, as shown by reference number 720, a first TCI codepoint (CP0) may indicate a first pair of unified TCIs (TCI1A and TCI1B), and a second TCI codepoint (CP1) may indicate a second pair of unified TCIs (TCI2A and TCI2B).

In some aspects, the indicated pair of unified TCIs may be a pair of joint downlink and uplink TCI indications. In this case, each of the first unified TCI and the second unified TCI indicates a respective TCI state to be used for one or more downlink communications and one or more uplink communications. In some aspects, the indicated pair of unified TCIs may be a pair of separate downlink TCI indications. In this case, each of the first unified TCI and the second unified TCI indicates a respective TCI state that may be used for multiple downlink communications. In some aspects, the indicated pair of unified TCIs may be a pair of separate uplink TCI indications. In this case, each of the first unified TCI and the second unified TCI indicates a respective TCI state that may be used for multiple uplink communications.

As further shown in FIG. 7, and by reference number 725, the UE 120 may communicate with the first TRP 705-1 and/or the second TRP 705-2 using beam directions associated with the pair of unified TCIs (e.g., the first unified TCI and the second unified TCI). The UE 120 may use the beam directions associated with the first and second unified TCIs for downlink communications from the first TRP 705-1 and/or the second TRP 705-2 and/or uplink communications to the first TRP 705-1 and/or the second TRP 705-2 based at least in part on the configuration information. In some aspects, the UE 120 may apply the first and second unified TCIs to reception of PDCCH communications and/or PDSCH communication and/or transmission of PUSCH communications and/or PUCCH communications based at least in part on the respective repetition modes indicated in the configuration information for PDCCH, PDSCH, PUSCH, and/or PUCCH. In some aspects, the UE 120 may apply the first and second unified TCIs to reception of downlink reference signals (e.g., CSI-RSs) and/or transmission of uplink reference signals (e.g., SRSs) based at least in part on the list of configured reference signals included in the configuration information.

In some aspects, the pair of unified TCIs may include a pair of joint uplink and downlink TCI indications to be applied to one or more downlink communications (e.g., PDCCH and/or PDSCH communications) and one or more uplink communications (e.g., PUSCH and/or PUCCH communications). In some aspects, the pair of unified TCIs may include a pair of joint uplink and downlink TCI indications to be applied to one or more downlink reference signals (e.g., CSI-RSs) and/or one or more uplink reference signals (e.g., SRSs).

In some aspects, the pair of unified TCIs may include a pair of separate downlink TCI indications to be applied to one or more downlink communications (e.g., PDCCH and/or PDSCH communications). In some aspects, the pair of unified TCIs may include a pair of separate downlink TCI indications to be applied to one or more downlink reference signals (e.g., CSI-RSs).

In some aspects, the pair of unified TCIs may include a pair of separate uplink TCI indications to be applied to one or more uplink communications (e.g., PUCCH and/or PUSCH communications). In some aspects, the pair of unified TCIs may include a pair of separate uplink TCI indications to be applied to one or more uplink reference signals (e.g., SRSs).

In some aspects, when the UE 120 is configured in the single DCI multiple-TRP mode, the pair of unified TCIs may indicate beam directions to be applied, by the UE 120, for repetition of communications on a physical channel. In a case in which the pair of unified TCIs are to be applied to PDCCH reception by the UE 120 (e.g., the pair of unified TCIs includes a pair of joint downlink and uplink TCI indications or a pair of separate downlink indications), the UE 120 may apply the first and second unified TCIs to receiving first and second transmissions of a PDCCH communication, respectively, based at least in part on the repetition mode configured for PDCCH. In some aspects, when the PDCCH repetition mode is configured for the UE 120 (e.g., non-SFN PDCCH repetitions), the configuration information may identify the first CORESET list and the second CORESET list. In this case, the UE 120 may apply the first unified TCI to the first CORESET list, and the UE 120 may apply the second unified TCI to the second CORESET list. For example, the UE 120 may determine a first CORESET, from the first CORESET list, by applying the first unified TCI to the first CORESET list, and the UE 120 may determine a second CORESET, from the second CORESET list, by applying the second unified TCI to the second CORESET list. The UE 120 may use a first beam direction associated with the first unified TCI to monitor a first search space associated with the first CORESET for a first transmission of the PDCCH communication, and the UE 120 may use a second beam direction associated with the second unified TCI to monitor a second search space associated with the second CORESET for a second transmission (e.g., a repetition) of the PDCCH communication. The UE 120 may receive the first transmission of the PDCCH communication in the first CORESET using the first beam direction associated with the first unified TCI and/or the second transmission of the PDCCH communication in the second CORESET using the second beam direction associated with the second unified TCI. In some aspects, the first and second unified TCIs may indicate beam directions associated with different TRPs 705 or the same TRP 705. For example, in some aspects, the first TRP 705-1 may transmit the first transmission of the PDCCH communication, and the second TRP 705-2 may transmit the second transmission (e.g., the repetition) of the PDCCH communication. In some aspects, the same TRP (e.g., the first TRP 705-1 or the second TRP 705-2) may transmit both the first transmission PDCCH communication and the second transmission (e.g., the repetition of the PDCCH communication).

In some aspects, in a case in which the SFN PDCCH mode is configured for the UE 120, the UE 120 may apply the first and second unified TCIs to each CORESET in the list of CORESETs configured for the SFN PDCCH mode. In this case, for an indicated CORESET in the list of CORESETs, the UE 120 may apply the first unified TCI and the second unified TCI for reception of a PDCCH communication transmitted using SFN transmission from the first TRP 705-1 and the second TRP 705-2. For example, the UE 120 may monitor a search space associated with the CORESET using a first beam direction associated with the first TCI for a first transmission of the PDCCH communication from the first TRP 705-1, and/or the UE 120 may monitor the search space associated with the CORESET using a second beam direction associated with the second TCI for a second transmission of the PDCCH communication from the second TRP 705-2. The first TRP 705-1 and the second TRP 705-2 may transmit the first and second transmissions of PDCCH communication, respectively, using the same time and frequency resources. The UE 120 may receive at least one of the first transmission of the PDCCH communication from the first TRP 705-1 using the first beam direction or the second transmission of the PDCCH communication from the second TRP 705-2 using the second beam direction.

In a case in which the pair of unified TCIs are to be applied to PDSCH reception by the UE 120 (e.g., the pair of unified TCIs includes a pair of joint downlink and uplink TCI indications or a pair of separate downlink indications), the UE 120 may apply the first and second unified TCIs to receiving transmissions of a PDSCH communication based at least in part on the repetition mode configured for PDSCH. In some aspects, when a PDSCH repetition mode is configured for the UE 120, the UE 120 may apply the first and second unified TCIs to first and second repetition occasions for the PDSCH, respectively, based at least in part on the PDSCH repetition mode. For example, the PDSCH repetition mode may be an inter-slot TDM repetition mode, an intra-slot TDM repetition mode, an FDM repetition mode, or an SDM repetition mode. The UE 120 may determine a first set of repetition occasions for the PDSCH communication, and a second set of repetition occasions for the PDSCH communication based at least in part on the PDSCH repetition mode. The UE 120 may apply the first unified TCI to the first set of repetition occasions, and the UE 120 may apply the second unified TCI to the second set of repetition occasions. For example, the UE 120 may monitor the first set of repetition occasions for the PDSCH communication using a first beam direction associated with the first unified TCI, and the UE 120 may monitor the second set of repetition occasions for the PDSCH communication using a second beam direction associated with the second unified TCI. In some aspects, the first and second unified TCIs may indicate beam directions associated with different TRPs 705 or the same TRP 705. For example, in some aspects, the first TRP 705-1 may transmit the PDSCH communication in the first set of repetition occasions, and the second TRP 705-2 may transmit the PDSCH communication in the second set of repetition occasions. In some aspects, the same TRP (e.g., the first TRP 705-1 or the second TRP 705-2) may transmit the PDSCH communication in the first and second sets of repetition occasions.

In some aspects, in a case in which the SFN PDSCH mode is configured for the UE 120, the UE 120 may apply the first and second unified TCIs to each SFN transmission of the PDSCH by the first TRP 705-1 and the second TRP 705-2. In this case, the first TRP 705-1 and the second TRP 705-2 may transmit the first and second transmissions of PDSCH communication, respectively, using the same time and frequency resources. The UE 120 may receive at least one of the first transmission of the PDSCH communication from the first TRP 705-1 using a first beam direction associated with the first unified TCI or the second transmission of the PDSCH communication from the second TRP 705-2 using a second beam direction associated with the second unified TCI.

In a case in which the pair of unified TCIs are to be applied to PUSCH and/or PUCCH transmission by the UE 120 (e.g., the pair of unified TCIs includes a pair of joint downlink and uplink TCI indications or a pair of separate uplink indications), the UE 120 may apply the first and second unified TCIs to transmissions of the PUSCH/PUCCH communication based at least in part on the repetition mode configured for PUSCH/PUCCH. In some aspects, when a PUSCH/PUCCH repetition mode is configured for the UE 120, the UE 120 may apply the first and second unified TCIs to first and second repetition occasions for the PUSCH/PUCCH, respectively, based at least in part on the PUSCH/PUCCH repetition mode. For example, the PUSCH/PUCCH repetition mode may be an inter-slot TDM repetition mode, an intra-slot TDM repetition mode, an FDM repetition mode, or an SDM repetition mode. The UE 120 may determine a first set of repetition occasions for transmitting the PUSCH/PUCCH communication, and a second set of repetition occasions for transmitting the PUSCH/PUCCH communication based at least in part on the PUSCH/PUCCH repetition mode. The UE 120 may apply the first unified TCI to the first set of repetition occasions, and the UE 120 may apply the second unified TCI to the second set of repetition occasions. For example, the UE 120 may transmit the PUSCH/PUCCH communication using a first beam associated with the first unified TCI in the first set of repetition occasions, and the UE 120 may transmit the PUSCH/PUCCH communication using a second beam associated with the second unified TCI in the second set of repetition occasions. In some aspects, the first and second unified TCIs may indicate beam directions associated with different TRPs 705 or the same TRP 705. For example, in some aspects, the UE 120 may transmit the PUSCH/PUCCH communication to the first TRP 705-1 in the first set of repetition occasions, and the UE 120 may transmit the PUSCH/PUCCH communication to second in the second set of repetition occasions. In some aspects, the UE 120 may transmit the PUSCH/PUCCH communication to same TRP (e.g., the first TRP 705-1 or the second TRP 705-2) in the first and second sets of repetition occasions.

In some aspects, in a case in which an SFN PUSCH mode and/or an SFN PUCCH is configured for the UE 120, the UE 120 may transmit a first transmission of a PUSCH/PUCCH communication to the first TRP 705-1 and a second transmission of the PUSCH/PUCCH communication to the second TRP 705-2 using the same time and frequency resources. In this case, the UE 120 may transmit the first transmission of the PUSCH/PUCCH communication to the first TRP 705-1 using a first beam direction associated with the first unified TCI, and the UE 120 may transmit the second transmission of the PUSCH/PUCCH communication to the second TRP 705-2 using a second beam direction associated with the second unified TCI.

In some aspects, when the UE 120 is configured in the single DCI multiple-TRP mode, the pair of unified TCIs may indicate beam directions to be applied, by the UE 120, for receiving downlink reference signals (e.g., CSI-RSs) and/or transmitting uplink reference signals (e.g., SRSs). In a case in which the pair of unified TCIs are to be applied to CSI-RS reception by the UE 120 (e.g., the pair of unified TCIs includes a pair of joint downlink and uplink TCI indications or a pair of separate downlink indications), the UE 120 may apply the first and second unified TCIs to receiving transmissions of CSI-RSs based at least in part on the lists of CSI-RSs or CSI-RS sets included in the configuration information. For example, the configuration information may include a first list of CSI-RSs or CSI-RS sets and a second list of CSI-RSs or CSI-RS sets. For another example, the UE 120 may be configured with two CSI-RS resources respectively associated with two SRS sets configured for non-codebook based uplink MIMO, and the first list of CSI-RSs may include one of the two CSI-RS resources (such as the CSI-RS associated with a lower SRS set ID), and the second list of CSI-RSs may include the other one of the two CSI-RS resources (such as the CSI-RS associated with a higher SRS set ID). In some aspects, the UE 120 may apply the first unified TCI to the first list of CSI-RSs or CSI-RS sets, and the UE 120 may apply the second unified TCI to the second list of CSI-RSs or CSI-RS sets. For example, the UE 120 may receive a first CSI-RS or CSI-RS set from the first list of CSI-RSs or CSI-RS sets using a first beam direction associated with the first unified TCI, and the UE 120 may receive a second CSI-RS or CSI-RS set from the second list of CSI-RSs or CSI-RS sets using a second beam direction associated with the second unified TCI. In some aspects, the first and second unified TCIs may indicate beam directions associated with different TRPs 705 or the same TRP 705. For example, in some aspects, the first TRP 705-1 may transmit the first CSI-RS or CSI-RS set, and the second TRP 705-2 may transmit the second CSI-RS or CSI-RS set. In some aspects, the same TRP (e.g., the first TRP 705-1 or the second TRP 705-2) may transmit the first CSI-RS or CSI-RS set and the second CSI-RS or CSI-RS set.

In some aspects, in a case in which the pair of unified TCIs are to be applied to SRS transmission by the UE 120 (e.g., the pair of unified TCIs includes a pair of joint downlink and uplink TCI indications or a pair of separate uplink indications), the UE 120 may apply the first and second unified TCIs to transmissions of SRSs based at least in part on the lists of SRSs or SRS sets included in the configuration information. For example, the configuration information may include a first list of SRSs or SRS sets and a second list of SRSs or SRS sets. For another example, the UE 120 may be configured with two SRS sets both for non-codebook based uplink MIMO, both for codebook based uplink MIMO or both for antenna switching, and the first list of SRS sets may include one set of the two SRS sets (such as the SRS set with a lower SRS set ID), and the second list of SRS sets may include the other set of the two SRS sets (such as the SRS set with a higher SRS set ID). In some aspects, the UE 120 may apply the first unified TCI to the first list of SRSs or SRS sets, and the UE 120 may apply the second unified TCI to the second list of SRSs or SRS sets. For example, the UE 120 may transmit a first SRS or SRS set from the first list of SRSs or SRS sets using a first beam direction associated with the first unified TCI, and the UE 120 may transmit a second SRS or SRS set from the second list of SRSs or SRS sets using a second beam direction associated with the second unified TCI. In some aspects, the first and second unified TCIs may indicate beam directions associated with different TRPs 705 or the same TRP 705. For example, in some aspects, the UE 120 may transmit the first SRS or SRS set to the first TRP 705-1, and the UE 120 may transmit the second SRS or SRS set to the second TRP 705-2. In some aspects, the UE 120 may transmit the first SRS or SRS set and the second SRS or SRS set to the same TRP (e.g., the first TRP 705-1 or the second TRP 705-2).

As described above, the UE 120 may receive configuration information associated with a single DCI multiple-TRP mode. The configuration information may indicate respective repetition modes for one or more physical channels and/or a list of configured reference signals. The UE 120 may receive an indication of a pair of unified TCIs, and the UE 120 may communicate with at least one of the first TRP 705-1 or the second TRP 705-2 using beam directions associated with the pair of unified TCIs based at least in part on the configuration information. As a result, the UE 120 may determine which beams to use for receiving and/or transmitting communications and/or reference signals in the single DCI multiple-TRP mode. This may result in increased reliability and decreased latency for multiple-TRP communications for the UE 120.

As indicated above, FIG. 7 is provided as an example. Other examples may differ from what is described with respect to FIG. 7.

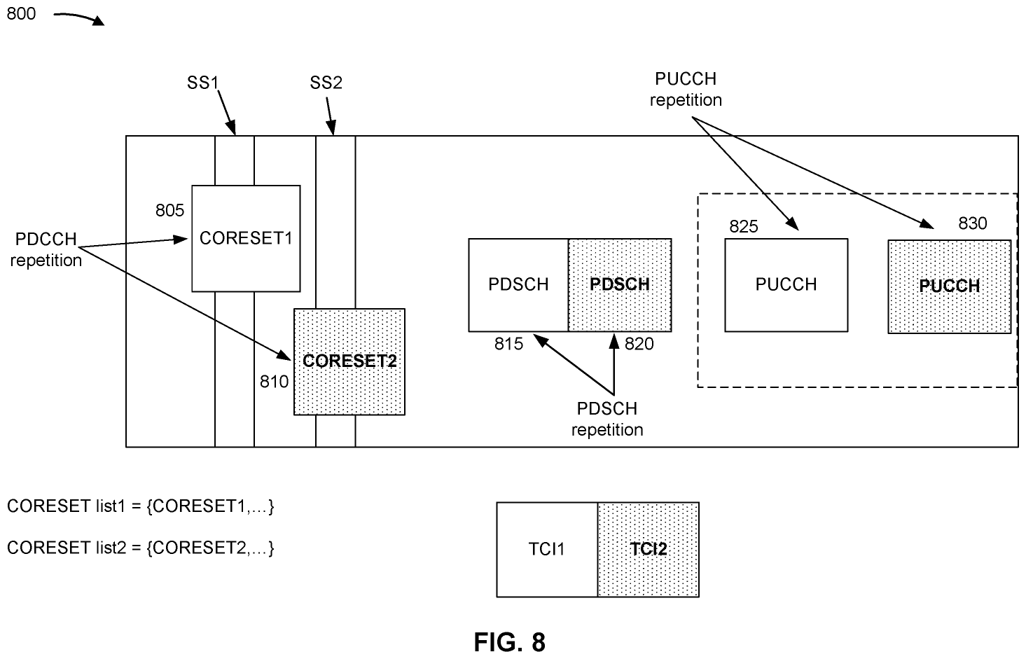

FIG. 8 is a diagram illustrating an example 800 associated with unified TCI indication for single DCI based multiple-TRP communications, in accordance with the present disclosure. As shown in FIG. 8, a UE may receive, from a base station (e.g., from a first TRP or a second TRP), an indication of a pair of unified TCIs including a first unified TCI (TCI1) and a second unified TCI (TCI2). As shown in example 800, TCI1 and TCI2 may be joint downlink and uplink TCI indications, and the UE may apply TCI1 and TCI2 for reception of PDCCH and PDSCH communications and for transmission of PUCCH communications.

The UE may be configured in a PDCCH repetition mode. In this case, the UE may apply TCI1 to a first CORESET list (CORESET list1), and the UE may apply TCI2 to a second CORESET list (CORESET list2). As shown by reference number 805, the UE may monitor a first search space (SS1) associated with a first CORESET (CORESET1) from the first CORESET list for a first transmission of the PDCCH communication using a first beam direction associated with TCI1. As shown by reference number 810, the UE may monitor a second search space (SS2) associated with a second CORESET (CORESET2) from the second CORESET list for a second transmission (e.g., a repetition) of the PDCCH communication using a second beam direction associated with TCI2. The UE may receive the PDCCH communication (e.g., from a first TRP and/or a second TRP) in CORESET1 using the first beam direction associated with TCI1 and CORESET2 using the second beam direction associated with TCI2. In some cases, the PDSCH may be determined to be received without any repetitions, i.e., received by a single TCI. For example, the PDSCH may be indicated by a fallback DCI format such as DCI1_0. For another example, the PDSCH may be scheduled within a time offset from the scheduling DCI. The UE 120 may select one TCI from the pair of indicated TCIs to receive a PDSCH which is determined or indicated to be received by a single TCI. The selected TCI may be the first TCI, or the TCI of lower ID in the pair of TCIs.

The UE may be configured in a PDSCH repetition mode. As shown by reference number 815, the UE may monitor a first repetition occasion for a PDSCH communication using the first beam direction associated with TCI1. As shown by reference number 820, the UE may monitor a second repetition occasion for the PDSCH communication using the second beam direction associated with TCI2. The UE may receive the PDSCH communication (e.g., from a first TRP and/or a second TRP) in at least one of the first repetition occasion using the first beam direction associated with TCI1 or the second repetition occasion using the second beam direction associated with TCI2.

The UE may be configured in a PUCCH repetition mode. As shown by reference number 825, the UE may transmit a PUCCH communication in a first repetition occasion using the first beam direction associated with TCI1. As shown by reference number 830, the UE may transmit the PUCCH communication in a second repetition occasion using the second beam direction associated with TCI2. In some cases, the PUCCH may be determined to be received without any repetitions, i.e., received by a single TCI. For example, the PUCCH may be indicated by a fallback DCI format such as DCI1_0. For another example, the PUCCH may be scheduled without any repetition. The UE 120 may select one TCI from the pair of indicated TCIs to receive a PUCCH which is determined or indicated to be received by a single TCI. The selected TCI may be the first TCI, or the TCI of lower ID in the pair of TCIs.

As indicated above, FIG. 8 is provided as an example. Other examples may differ from what is described with respect to FIG. 8.

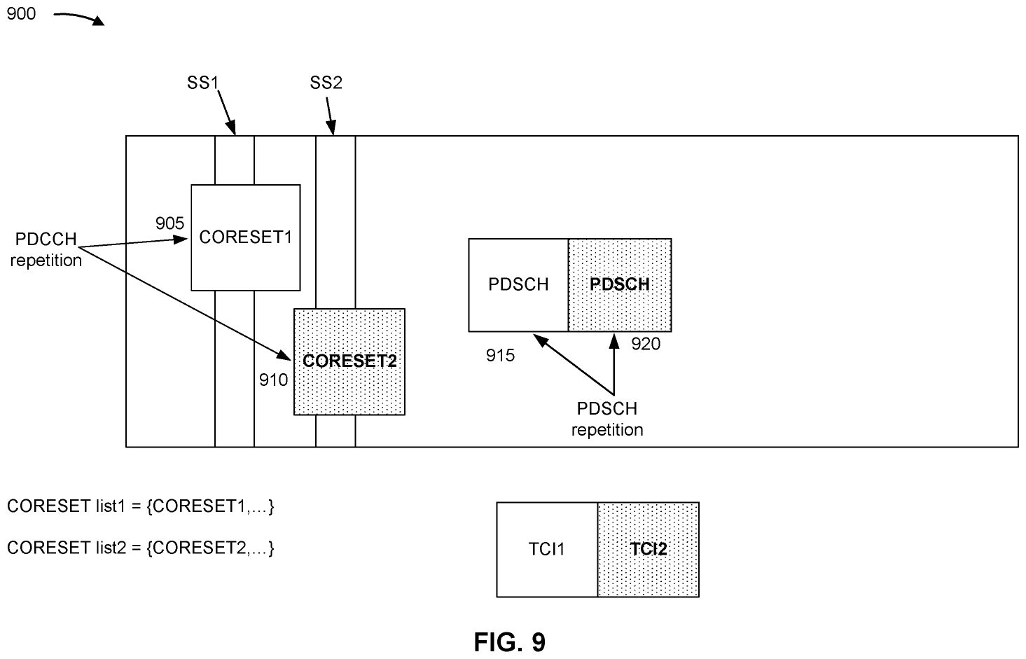

FIG. 9 is a diagram illustrating an example 900 associated with unified TCI indication for single DCI based multiple-TRP communications, in accordance with the present disclosure. As shown in FIG. 9, a UE may receive, from a base station (e.g., from a first TRP or a second TRP), an indication of a pair of unified TCIs including a first unified TCI (TCI1) and a second unified TCI (TCI2). As shown in example 900, TCI1 and TCI2 may be separate downlink TCI indications, and the UE may apply TCI1 and TCI2 for reception of PDCCH and PDSCH communications.

The UE may be configured in a PDCCH repetition mode. In this case, the UE may apply TCI1 to a first CORESET list (CORESET list1), and the UE may apply TCI2 to a second CORESET list (CORESET list2). As shown by reference number 905, the UE may monitor a first search space (SS1) associated with a first CORESET (CORESET1) from the first CORESET list for a first transmission of the PDCCH communication using a first beam direction associated with TCI1. As shown by reference number 910, the UE may monitor a second search space (SS2) associated with a second CORESET (CORESET2) from the second CORESET list for a second transmission (e.g., a repetition) of the PDCCH communication using a second beam direction associated with TCI2. The UE may receive the PDCCH communication (e.g., from a first TRP and/or a second TRP) in at least one of CORESET1 using the first beam direction associated with TCI1 or CORESET2 using the second beam direction associated with TCI2.

The UE may be configured in a PDSCH repetition mode. As shown by reference number 915, the UE may monitor a first repetition occasion for a PDSCH communication using the first beam direction associated with TCI1. As shown by reference number 920, the UE may monitor a second repetition occasion for the PDSCH communication using the second beam direction associated with TCI2. The UE may receive the PDSCH communication (e.g., from a first TRP and/or a second TRP) in at least one of the first repetition occasion using the first beam direction associated with TCI1 or the second repetition occasion using the second beam direction associated with TCI2.

As indicated above, FIG. 9 is provided as an example. Other examples may differ from what is described with respect to FIG. 9.

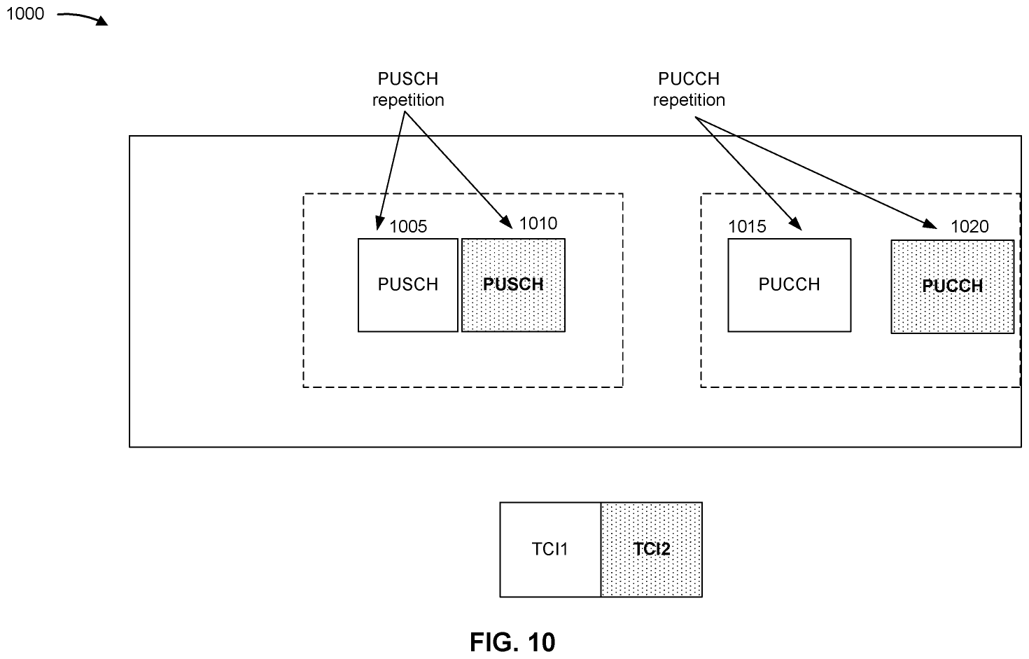

FIG. 10 is a diagram illustrating an example 1000 associated with unified TCI indication for single DCI based multiple-TRP communications, in accordance with the present disclosure. As shown in FIG. 10, a UE may receive, from a base station (e.g., from a first TRP or a second TRP), an indication of a pair of unified TCIs including a first unified TCI (TCI1) and a second unified TCI (TCI2). As shown in example 1000, TCI1 and TCI2 may be separate uplink TCI indications, and the UE may apply TCI1 and TCI2 for transmission of PUSCH and PUCCH communications.

The UE may be configured in a PUSCH repetition mode. As shown by reference number 1005, the UE may transmit a PUSCH communication in a first repetition occasion for the PUSCH communication using a first beam direction associated with TCI1. As shown by reference number 1010, the UE may transmit the PUSCH communication in a second repetition occasion for the PUSCH communication using a second beam direction associated with TCI2. In some cases, the PUSCH may be determined to be received without any repetitions, i.e., received by a single TCI. For example, the PUSCH may be indicated by a fallback DCI format such as DCI0_0. For another example, the PUSCH may be scheduled without any repetition. The UE 120 may select one TCI from the pair of indicated TCIs to receive a PUSCH which is determined or indicated to be received by a single TCI. The selected TCI may be the first TCI, or the TCI of lower ID in the pair of TCs. In some other aspects, the PUSCH may be scheduled by a DCI, and the DCI may determine which one of two indicated TCIs or both the indicated TCIs to be applied to transmit the PUSCH. For example, the DCI may include a field of two bits, where “00” means indicating the first TCI to be applied to transmit the scheduled PUSCH, “01” means indicating the second TCI to be applied to transmit the scheduled PUSCH, “10” means indicating the first TCI and the second TCI to be applied to transmit the scheduled PUSCH in order, and “11” means indicating the second TCI and the first TCI to be applied to transmit the scheduled PUSCH in order.

The UE may be configured in a PUCCH repetition mode. As shown by reference number 1015, the UE may transmit a PUCCH communication in a first repetition occasion for the PUCCH communication using the first beam direction associated with TCI1. As shown by reference number 1020, the UE may transmit the PUCCH communication in a second repetition occasion for the PUCCH communication using the second beam direction associated with TCI2.

As indicated above, FIG. 10 is provided as an example. Other examples may differ from what is described with respect to FIG. 10.

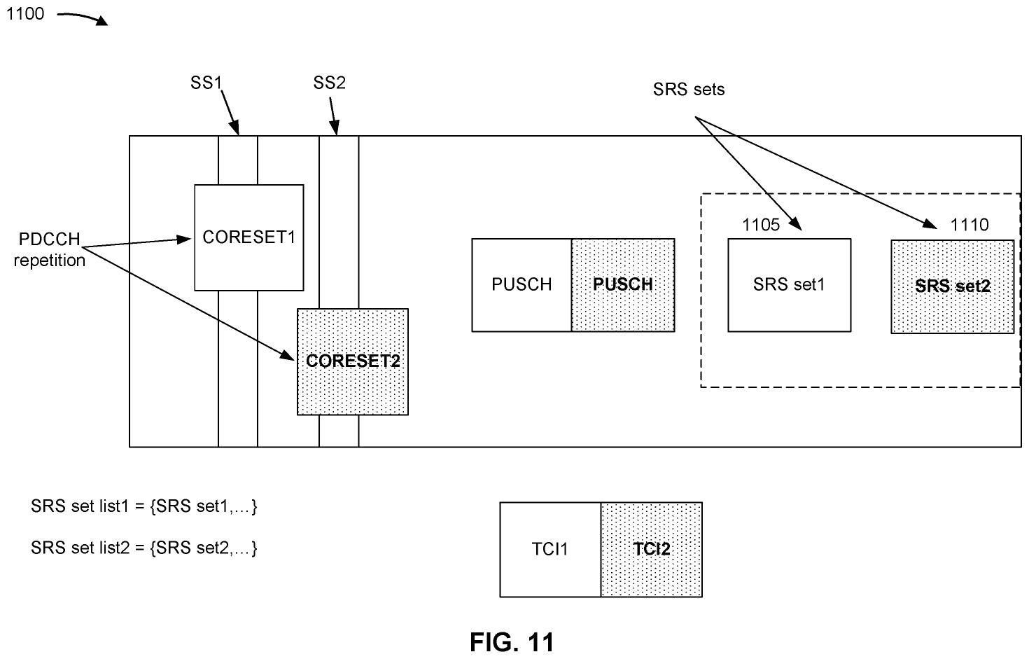

FIG. 11 is a diagram illustrating an example 1100 associated with unified TCI indication for single DCI based multiple-TRP communications, in accordance with the present disclosure. As shown in FIG. 11, a UE may receive, from a base station (e.g., from a first TRP or a second TRP), an indication of a pair of unified TCIs including a first unified TCI (TCI1) and a second unified TCI (TCI2). As shown in example 1100, TCI1 and TCI2 may be separate uplink TCI indications or joint downlink and uplink TCI indications, and the UE may apply TCI1 and TCI2 for transmission of SRS sets.

The UE may be configured with a first list of SRS sets (SRS set list1) and a second list of SRS sets (SRS set list2). The UE may apply TCI1 to the first list of SRS sets, and the UE may apply TCI2 to the second list of SRS sets. As shown by reference number 1105, the UE may transmit a first SRS set (SRS set1) using a first beam direction associated with TCI1. As shown by reference number 1110, the UE may transmit a second SRS set (SRS set2) using a second beam direction associated with TCI2.

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with unified TCI indication for single DCI based multiple-TRP communications.

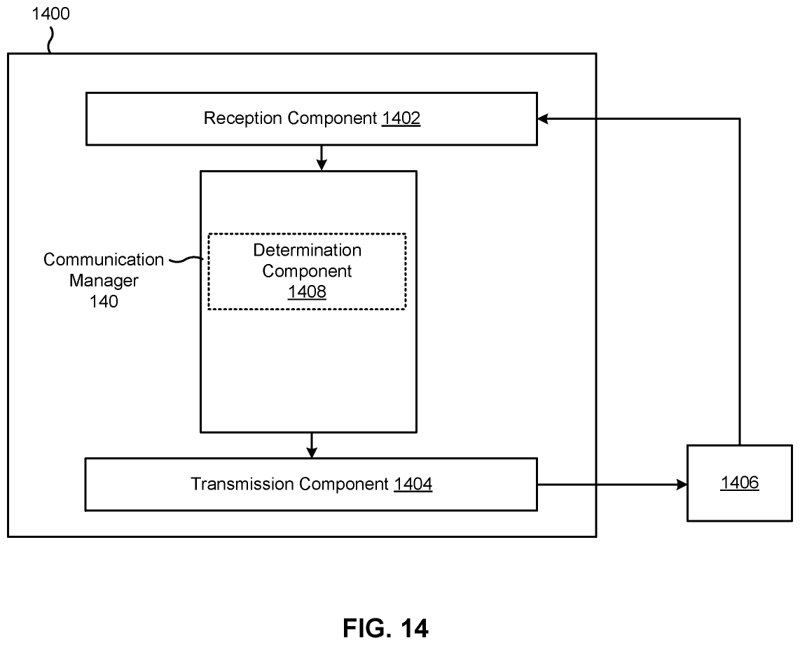

As shown in FIG. 12, in some aspects, process 1200 may include receiving configuration information associated with a single DCI multiple-TRP mode, wherein the configuration information indicates at least one of respective repetition modes for one or more physical channels or a list of configured reference signals (block 1210). For example, the UE (e.g., using communication manager 140 and/or reception component 1402, depicted in FIG. 14) may receive configuration information associated with a single DCI multiple-TRP mode, wherein the configuration information indicates at least one of respective repetition modes for one or more physical channels or a list of configured reference signals, as described above.

As further shown in FIG. 12, in some aspects, process 1200 may include receiving an indication of a pair of unified TCIs (block 1220). For example, the UE (e.g., using communication manager 140 and/or reception component 1402, depicted in FIG. 14) may receive an indication of a pair of unified TCIs, as described above.

As further shown in FIG. 12, in some aspects, process 1200 may include communicating with at least one of a first TRP or a second TRP using beam directions associated with the pair of unified TCIs based at least in part on the configuration information (block 1230). For example, the UE (e.g., using communication manager 140, reception component 1402, and/or transmission component 1404, depicted in FIG. 14) may communicate with at least one of a first TRP or a second TRP using beam directions associated with the pair of unified TCIs based at least in part on the configuration information, as described above.

Process 1200 may include additional aspects, such as any single aspect or any combination of aspects described below and/or in connection with one or more other processes described elsewhere herein.

In a first aspect, receiving the indication of the pair of unified TCIs includes receiving a TCI codepoint that indicates a first unified TCI and a second unified TCI.

In a second aspect, alone or in combination with the first aspect, the pair of unified TCIs include a pair of joint downlink and uplink TCI indications or a pair of separate downlink TCI indications.

In a third aspect, alone or in combination with one or more of the first and second aspects, the configuration information indicates that a PDCCH repetition mode is configured for the UE, the configuration information identifies a first CORESET list and a second CORESET list, and communicating with at least one of the first TRP or the second TRP includes receiving at least one of a first transmission of a PDCCH communication, from the first TRP or the second TRP, in a first CORESET determined by applying a first unified TCI, of the pair of unified TCIs, to the first CORESET list, or a second transmission of the PDCCH communication, from the first TRP or the second TRP, in a second CORESET determined by applying a second unified TCI, of the pair of unified TCIs, to the second CORESET list.

In a fourth aspect, alone or in combination with one or more of the first through third aspects, the configuration information indicates that an SFN PDCCH mode is configured for the UE, the configuration information identifies a CORESET list, and communicating with at least one of the first TRP or the second TRP includes receiving at least one of a first transmission of a PDCCH communication, from the first TRP, in a CORESET from the CORESET list using a first beam direction associated with a first unified TCI, of the pair of unified TCIs, or a second transmission of the PDCCH communication, from the second TRP, in the CORESET from the CORESET list using a second beam direction associated with a second unified TCI, of the pair of unified TCIs.

In a fifth aspect, alone or in combination with one or more of the first through fourth aspects, the configuration information indicates that a PDSCH repetition mode is an inter-slot time division multiplexed repetition mode, an intra-slot time division multiplexed repetition mode, a frequency division multiplexed repetition mode, or a space division multiplexed repetition mode, and communicating with at least one of the first TRP or the second TRP includes applying a first unified TCI, of the pair of unified TCIs, to a first set of repetition occasions associated with a PDSCH communication based at least in part on the PDSCH repetition mode, and applying a second unified TCI, of the pair of unified TCIs, to a second set of repetition occasions associated with the PDSCH communication based at least in part on the PDSCH repetition mode.

In a sixth aspect, alone or in combination with one or more of the first through fifth aspects, the configuration information indicates that an SFN PDSCH mode is configured for the UE, and communicating with at least one of the first TRP or the second TRP includes receiving at least one of a first transmission of a PDSCH communication, from the first TRP, using a first beam direction associated with a first unified TCI of the pair of unified TCIs, or a second transmission of the PDSCH communication, from the second TRP, using a second beam direction associated with a second unified TCI of the pair of unified TCIs.

In a seventh aspect, alone or in combination with one or more of the first through sixth aspects, the list of configured reference signals includes a first list of CSI-RSs or CSI-RS sets and a second list of CSI-RSs or CSI-RS sets, and communicating with at least one of a first TRP or a second TRP includes receiving, from the first TRP or the second TRP, a first CSI-RS or CSI-RS set identified by applying a first unified TCI, of the pair of unified TCIs, to the first list of CSI-RSs or CSI-RS sets, and receiving, from the first TRP or the second TRP, a second CSI-RS or CSI-RS set identified by applying a second unified TCI, of the pair of unified TCIs, to the second list of CSI-RSs or CSI-RS sets.

In an eighth aspect, alone or in combination with one or more of the first through seventh aspects, the pair of unified TCIs include a pair joint downlink and uplink TCI indications or a pair of separate uplink TCI indications.

In a ninth aspect, alone or in combination with one or more of the first through eighth aspects, the configuration information indicates that a PUSCH or PUCCH repetition mode is an inter-slot time division multiplexed repetition mode, an intra-slot time division multiplexed repetition mode, a frequency division multiplexed repetition mode, or a space division multiplexed repetition mode, and communicating with at least one of the first TRP or the second TRP includes applying a first unified TCI, of the pair of unified TCIs, to a first set of repetition occasions associated with a PUSCH or PUCCH communication based at least in part on the PUSCH or PUCCH repetition mode, and applying a second unified TCI, of the pair of unified TCIs, to a second set of repetition occasions associated with the PUSCH or PUCCH communication based at least in part on the PUSCH or PUCCH repetition mode.

In a tenth aspect, alone or in combination with one or more of the first through ninth aspects, the configuration information indicates that an SFN PUSCH or PUCCH mode is configured for the UE, and communicating with at least one of the first TRP or the second TRP includes transmitting a first transmission of a PUSCH or PUCCH communication, to the first TRP, using a first beam direction associated with a first unified TCI of the pair of unified TCIs, and transmitting a second transmission of the PUSCH or PUCCH communication, to the second TRP, using a second beam direction associated with a second unified TCI of the pair of unified TCIs.

In an eleventh aspect, alone or in combination with one or more of the first through tenth aspects, the list of configured reference signals includes a first list of SRSs or SRS sets and a second list of SRSs or SRS sets, and communicating with at least one of a first TRP or a second TRP includes transmitting a first SRS or SRS set identified by applying a first unified TCI, of the pair of unified TCIs, to the first list of SRSs or SRS sets, and transmitting a second SRS or SRS set identified by applying a second unified TCI, of the pair of unified TCIs, to the second list of SRSs or SRS sets.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a base station, in accordance with the present disclosure. Example process 1300 is an example where the base station (e.g., base station 110) performs operations associated with unified TCI indication for single DCI based multiple-TRP communications.

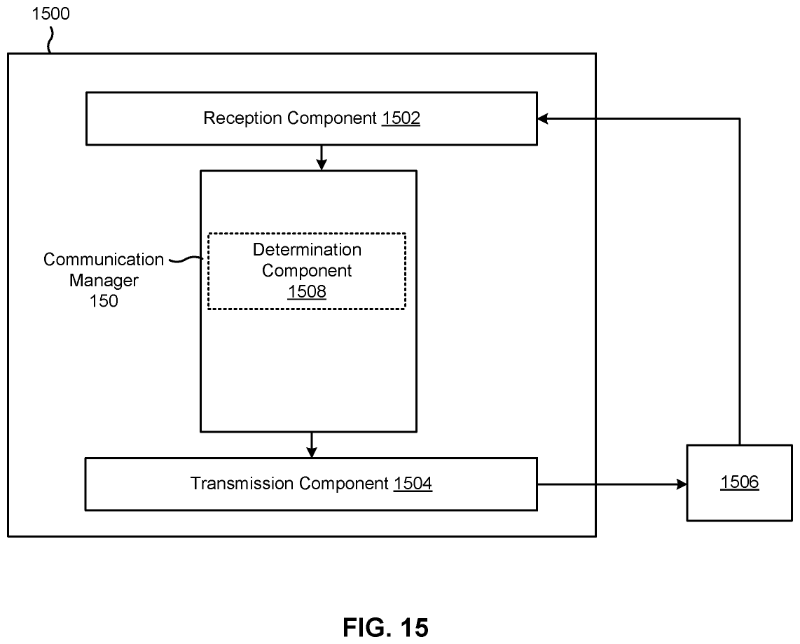

As shown in FIG. 13, in some aspects, process 1300 may include transmitting, to a UE, configuration information associated with a single DCI multiple-TRP mode, wherein the configuration information indicates at least one of respective repetition modes for one or more physical channels or a list of configured reference signals (block 1310). For example, the base station (e.g., using communication manager 150 and/or transmission component 1504, depicted in FIG. 15) may transmit, to a UE, configuration information associated with a single DCI multiple-TRP mode, wherein the configuration information indicates at least one of respective repetition modes for one or more physical channels or a list of configured reference signals, as described above.

As further shown in FIG. 13, in some aspects, process 1300 may include transmitting, to the UE, an indication of a pair of unified TCIs (block 1320). For example, the base station (e.g., using communication manager 150 and/or transmission component 1504, depicted in FIG. 15) may transmit, to the UE, an indication of a pair of unified TCIs, as described above.

As further shown in FIG. 13, in some aspects, process 1300 may include communicating with the UE using at least one of a first beam direction associated with a first unified TCI of the pair of TCIs or a second beam direction associated with a second unified TCI of the pair of unified TCIs (block 1330). For example, the base station (e.g., using communication manager 150, reception component 1502, and/or transmission component 1504, depicted in FIG. 15) may communicate with the UE using at least one of a first beam direction associated with a first unified TCI of the pair of TCIs or a second beam direction associated with a second unified TCI of the pair of unified TCIs, as described above.

Process 1300 may include additional aspects, such as any single aspect or any combination of aspects described below and/or in connection with one or more other processes described elsewhere herein.

In a first aspect, transmitting the indication of the pair of unified TCIs includes transmitting, to the UE, a TCI codepoint that indicates a first unified TCI and a second unified TCI.

In a second aspect, alone or in combination with the first aspect, the pair of unified TCIs include a pair of joint downlink and uplink TCI indications or a pair of separate downlink TCI indications.

In a third aspect, alone or in combination with one or more of the first and second aspects, the configuration information indicates that a PDCCH repetition mode is configured for the UE, the configuration information identifies a first CORESET list and a second CORESET list, and communicating with the UE includes transmitting, to the UE, at least one of a first transmission of a PDCCH communication in a first CORESET from the first CORESET list using a first beam direction associated with a first unified TCI, of the pair of unified TCIs, or a second transmission of the PDCCH communication in a second CORESET from the second CORESET list using a second beam direction associated with a second unified TCI, of the pair of unified TCIs, to the second CORESET list.

In a fourth aspect, alone or in combination with one or more of the first through third aspects, the configuration information indicates that an SFN PDCCH mode is configured for the UE, the configuration information identifies a CORESET list, and communicating with the UE includes transmitting at least one of a first transmission of a PDCCH communication in a CORESET from the CORESET list using a first beam direction associated with a first unified TCI, of the pair of unified TCIs, or a second transmission of the PDCCH communication in the CORESET from the CORESET list using a second beam direction associated with a second unified TCI, of the pair of unified TCIs.

In a fifth aspect, alone or in combination with one or more of the first through fourth aspects, the configuration information indicates that a PDSCH repetition mode is an inter-slot time division multiplexed repetition mode, an intra-slot time division multiplexed repetition mode, a frequency division multiplexed repetition mode, or a space division multiplexed repetition mode, and communicating with the UE includes at least one of transmitting, to the UE, a PDSCH communication in a first set of repetition occasions using a first beam direction associated with a first unified TCI, of the pair of unified TCIs, or transmitting, to the UE, the PDSCH communication in a second set of repetition occasions using a second beam direction associated with a second unified TCI, of the pair of unified TCIs.

In a sixth aspect, alone or in combination with one or more of the first through fifth aspects, the configuration information indicates that an SFN PDSCH mode is configured for the UE, and communicating with the UE includes transmitting at least one of a first transmission of a PDSCH communication using a first beam direction associated with a first unified TCI of the pair of unified TCIs, or a second transmission of the PDSCH communication using a second beam direction associated with a second unified TCI of the pair of unified TCIs.

In a seventh aspect, alone or in combination with one or more of the first through sixth aspects, the list of configured reference signals includes a first list of CSI-RSs or CSI-RS sets and a second list of CSI-RSs or CSI-RS sets, and communicating with the UE includes at least one of transmitting, to the UE, a first CSI-RS or CSI-RS set from the first list of CSI-RSs or CSI-RS sets using a first beam direction associated with a first unified TCI, of the pair of unified TCIs, or transmitting, to the UE, a second CSI-RS or CSI-RS set from the second list of CSI-RSs or CSI-RS sets using a second beam direction associated with a second unified TCI, of the pair of unified TCIs.

In an eighth aspect, alone or in combination with one or more of the first through seventh aspects, the pair of unified TCIs include a pair joint downlink and uplink TCI indications or a pair of separate uplink TCI indications.

In a ninth aspect, alone or in combination with one or more of the first through eighth aspects, the configuration information indicates that a PUSCH or PUCCH repetition mode is an inter-slot time division multiplexed repetition mode, an intra-slot time division multiplexed repetition mode, a frequency division multiplexed repetition mode, or a space division multiplexed repetition mode, and communicating with the UE includes at least one of receiving, from the UE, a transmission of a PUSCH or PUCCH communication in a first set of repetition occasions using a first beam direction associated with a first unified TCI, of the pair of unified TCIs, or receiving, from the UE, a transmission of the PUSCH or PUCCH communication in a second set of repetition occasions using a second beam direction associated with a second unified TCI, of the pair of unified TCIs.

In a tenth aspect, alone or in combination with one or more of the first through ninth aspects, the configuration information indicates that an SFN PUSCH or PUCCH mode is configured for the UE, and communicating with the UE includes at least one of receiving, from the UE, a first transmission of a PUSCH or PUCCH communication using a first beam direction associated with a first unified TCI of the pair of unified TCIs, or receiving, from the UE, a second transmission of the PUSCH or PUCCH communication, using a second beam direction associated with a second unified TCI of the pair of unified TCIs.

In an eleventh aspect, alone or in combination with one or more of the first through tenth aspects, the list of configured reference signals includes a first list of SRSs or SRS sets and a second list of SRSs or SRS sets, and communicating with the UE includes at least one of receiving, from the UE, a first SRS or SRS set from the first list of SRSs or SRS sets using a first beam direction associated with a first unified TCI, of the pair of unified TCIs, or receiving, from the UE, a second SRS or SRS set from the second list of SRSs or SRS sets using a second beam direction associated with a second unified TCI, of the pair of unified TCIs.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a determination component 1408.

In some aspects, the apparatus 1400 may be configured to perform one or more operations described herein in connection with FIGS. 7-11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive configuration information associated with a single DCI multiple-TRP mode, wherein the configuration information indicates at least one of respective repetition modes for one or more physical channels or a list of configured reference signals. The reception component 1402 may receive an indication of a pair of unified TCIs. The reception component 1402 and/or the transmission component 1404 may communicate with at least one of a first TRP or a second TRP using beam directions associated with the pair of unified TCIs based at least in part on the configuration information. The determination component 1408 may determine the communications for which to use the beam directions associated with the pair of unified TCIs based at least in part on the configuration information.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a base station, or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a determination component 1508.

In some aspects, the apparatus 1500 may be configured to perform one or more operations described herein in connection with FIGS. 7-11. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the base station described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the base station described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the base station described in connection with FIG. 2. In some aspects, the transmission component 1504 may be co-located with the reception component 1502 in a transceiver.

The transmission component 1504 may transmit, to a UE, configuration information associated with a single DCI multiple-TRP mode, wherein the configuration information indicates at least one of respective repetition modes for one or more physical channels or a list of configured reference signals. The transmission component 1504 may transmit, to the UE, an indication of a pair of unified TCIs. The reception component 1502 and/or the transmission component 1504 may communicate with the UE using at least one of a first beam direction associated with a first unified TCI of the pair of TCIs or a second beam direction associated with a second unified TCI of the pair of unified TCIs. The determination component may determine the configuration information and/or the indication of the pair of unified TCIs to transmit to the UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving configuration information associated with a single downlink control information (DCI) multiple transmit receive point (TRP) mode, wherein the configuration information indicates at least one of respective repetition modes for one or more physical channels or a list of configured reference signals; receiving an indication of a pair of unified transmission configuration indicators (TCIs); and communicating with at least one of a first TRP or a second TRP using beam directions associated with the pair of unified TCIs based at least in part on the configuration information.

Aspect 2: The method of Aspect 1, wherein receiving the indication of the pair of unified TCIs comprises: receiving a TCI codepoint that indicates a first unified TCI and a second unified TCI.

Aspect 3: The method of any of Aspects 1-2, wherein the pair of unified TCIs include a pair of joint downlink and uplink TCI indications or a pair of separate downlink TCI indications.

Aspect 4: The method of Aspect 3, wherein the configuration information indicates that a physical downlink control channel (PDCCH) repetition mode is configured for the UE, wherein the configuration information identifies a first control resource set (CORESET) list and a second CORESET list, and wherein communicating with at least one of the first TRP or the second TRP comprises: receiving at least one of: a first transmission of a PDCCH communication, from the first TRP or the second TRP, in a first CORESET determined by applying a first unified TCI, of the pair of unified TCIs, to the first CORESET list, or a second transmission of the PDCCH communication, from the first TRP or the second TRP, in a second CORESET determined by applying a second unified TCI, of the pair of unified TCIs, to the second CORESET list.

Aspect 5: The method of Aspect 3, wherein the configuration information indicates that a single frequency network (SFN) physical downlink control channel (PDCCH) mode is configured for the UE, wherein the configuration information identifies a control resource set (CORESET) list, and wherein communicating with at least one of the first TRP or the second TRP comprises: receiving at least one of: a first transmission of a PDCCH communication, from the first TRP, in a CORESET from the CORESET list using a first beam direction associated with a first unified TCI, of the pair of unified TCIs, or a second transmission of the PDCCH communication, from the second TRP, in the CORESET from the CORESET list using a second beam direction associated with a second unified TCI, of the pair of unified TCIs.

Aspect 6: The method of any of Aspects 3-5, wherein the configuration information indicates that a physical downlink shared channel (PDSCH) repetition mode is an inter-slot time division multiplexed repetition mode, an intra-slot time division multiplexed repetition mode, a frequency division multiplexed repetition mode, or a space division multiplexed repetition mode, and wherein communicating with at least one of the first TRP or the second TRP comprises: applying a first unified TCI, of the pair of unified TCIs, to a first set of repetition occasions associated with a PDSCH communication based at least in part on the PDSCH repetition mode; and applying a second unified TCI, of the pair of unified TCIs, to a second set of repetition occasions associated with the PDSCH communication based at least in part on the PDSCH repetition mode.

Aspect 7: The method of any of Aspects 3-5, wherein the configuration information indicates that a single frequency network (SFN) physical downlink shared channel (PDSCH) mode is configured for the UE, and wherein communicating with at least one of the first TRP or the second TRP comprises: receiving at least one of: a first transmission of a PDSCH communication, from the first TRP, using a first beam direction associated with a first unified TCI of the pair of unified TCIs, or a second transmission of the PDSCH communication, from the second TRP, using a second beam direction associated with a second unified TCI of the pair of unified TCIs.

Aspect 8: The method of any of Aspects 3-7, wherein the list of configured reference signals includes a first list of channel state information reference signals (CSI-RSs) or CSI-RS sets and a second list of CSI-RSs or CSI-RS sets, and wherein communicating with at least one of a first TRP or a second TRP comprises: receiving, from the first TRP or the second TRP, a first CSI-RS or CSI-RS set identified by applying a first unified TCI, of the pair of unified TCIs, to the first list of CSI-RSs or CSI-RS sets; and receiving, from the first TRP or the second TRP, a second CSI-RS or CSI-RS set identified by applying a second unified TCI, of the pair of unified TCIs, to the second list of CSI-RSs or CSI-RS sets.

Aspect 9: The method of any of Aspects 1-8, wherein the pair of unified TCIs include a pair joint downlink and uplink TCI indications or a pair of separate uplink TCI indications.

Aspect 10: The method of Aspect 9, wherein the configuration information indicates that a physical uplink shared channel (PUSCH) or physical uplink control channel (PUCCH) repetition mode is an inter-slot time division multiplexed repetition mode, an intra-slot time division multiplexed repetition mode, a frequency division multiplexed repetition mode, or a space division multiplexed repetition mode, and wherein communicating with at least one of the first TRP or the second TRP comprises: applying a first unified TCI, of the pair of unified TCIs, to a first set of repetition occasions associated with a PUSCH or PUCCH communication based at least in part on the PUSCH or PUCCH repetition mode; and applying a second unified TCI, of the pair of unified TCIs, to a second set of repetition occasions associated with the PUSCH or PUCCH communication based at least in part on the PUSCH or PUCCH repetition mode.

Aspect 11: The method of Aspect 9, wherein the configuration information indicates that a single frequency network (SFN) physical uplink shared channel (PUSCH) or physical uplink control channel (PUCCH) mode is configured for the UE, and wherein communicating with at least one of the first TRP or the second TRP comprises: transmitting a first transmission of a PUSCH or PUCCH communication, to the first TRP, using a first beam direction associated with a first unified TCI of the pair of unified TCIs; and transmitting a second transmission of the PUSCH or PUCCH communication, to the second TRP, using a second beam direction associated with a second unified TCI of the pair of unified TCIs.

Aspect 12: The method of any of Aspects 9-11, wherein the list of configured reference signals includes a first list of sounding reference signals (SRSs) or SRS sets and a second list of SRSs or SRS sets, and wherein communicating with at least one of a first TRP or a second TRP comprises: transmitting a first SRS or SRS set identified by applying a first unified TCI, of the pair of unified TCIs, to the first list of SRSs or SRS sets; and transmitting a second SRS or SRS set identified by applying a second unified TCI, of the pair of unified TCIs, to the second list of SRSs or SRS sets.

Aspect 13: A method of wireless communication performed by abase station, comprising: transmitting, to a user equipment (UE), configuration information associated with a single downlink control information (DCI) multiple transmit receive point (TRP) mode, wherein the configuration information indicates at least one of respective repetition modes for one or more physical channels or a list of configured reference signals; transmitting, to the UE, an indication of a pair of unified transmission configuration indicators (TCIs); and communicating with the UE using at least one of a first beam direction associated with a first unified TCI of the pair of TCs or a second beam direction associated with a second unified TCI of the pair of unified TCIs.

Aspect 14: The method of Aspect 13, wherein transmitting the indication of the pair of unified TCIs comprises: transmitting, to the UE, a TCI codepoint that indicates a first unified TCI and a second unified TCI.

Aspect 15: The method of any of Aspects 13-14, wherein the pair of unified TCIs include a pair of joint downlink and uplink TCI indications or a pair of separate downlink TCI indications.

Aspect 16: The method of Aspect 15, wherein the configuration information indicates that a physical downlink control channel (PDCCH) repetition mode is configured for the UE, wherein the configuration information identifies a first control resource set (CORESET) list and a second CORESET list, and wherein communicating with the UE comprises: transmitting, to the UE, at least one of a first transmission of a PDCCH communication in a first CORESET from the first CORESET list using a first beam direction associated with a first unified TCI, of the pair of unified TCIs, or a second transmission of the PDCCH communication in a second CORESET from the second CORESET list using a second beam direction associated with a second unified TCI, of the pair of unified TCIs, to the second CORESET list.

Aspect 17: The method of Aspect 15, wherein the configuration information indicates that a single frequency network (SFN) physical downlink control channel (PDCCH) mode is configured for the UE, wherein the configuration information identifies a control resource set (CORESET) list, and wherein communicating with the UE comprises: transmitting at least one of: a first transmission of a PDCCH communication in a CORESET from the CORESET list using a first beam direction associated with a first unified TCI, of the pair of unified TCIs, or a second transmission of the PDCCH communication in the CORESET from the CORESET list using a second beam direction associated with a second unified TCI, of the pair of unified TCIs.

Aspect 18: The method of any of Aspects 15-17, wherein the configuration information indicates that a physical downlink shared channel (PDSCH) repetition mode is an inter-slot time division multiplexed repetition mode, an intra-slot time division multiplexed repetition mode, a frequency division multiplexed repetition mode, or a space division multiplexed repetition mode, and wherein communicating with the UE comprises at least one of: transmitting, to the UE, a PDSCH communication in a first set of repetition occasions using a first beam direction associated with a first unified TCI, of the pair of unified TCIs; or transmitting, to the UE, the PDSCH communication in a second set of repetition occasions using a second beam direction associated with a second unified TCI, of the pair of unified TCIs.

Aspect 19: The method of any of Aspects 15-17, wherein the configuration information indicates that a single frequency network (SFN) physical downlink shared channel (PDSCH) mode is configured for the UE, and wherein communicating with the UE comprises: transmitting at least one of: a first transmission of a PDSCH communication using a first beam direction associated with a first unified TCI of the pair of unified TCIs, or a second transmission of the PDSCH communication using a second beam direction associated with a second unified TCI of the pair of unified TCIs.

Aspect 20: The method of any of Aspects 15-19, wherein the list of configured reference signals includes a first list of channel state information reference signals (CSI-RSs) or CSI-RS sets and a second list of CSI-RSs or CSI-RS sets, and wherein communicating with the UE comprises at least one of: transmitting, to the UE, a first CSI-RS or CSI-RS set from the first list of CSI-RSs or CSI-RS sets using a first beam direction associated with a first unified TCI, of the pair of unified TCIs; or transmitting, to the UE, a second CSI-RS or CSI-RS set from the second list of CSI-RSs or CSI-RS sets using a second beam direction associated with a second unified TCI, of the pair of unified TCIs.

Aspect 21: The method of any of Aspects 13-20, wherein the pair of unified TCIs include a pair joint downlink and uplink TCI indications or a pair of separate uplink TCI indications.

Aspect 22: The method of Aspect 21, wherein the configuration information indicates that a physical uplink shared channel (PUSCH) or physical uplink control channel (PUCCH) repetition mode is an inter-slot time division multiplexed repetition mode, an intra-slot time division multiplexed repetition mode, a frequency division multiplexed repetition mode, or a space division multiplexed repetition mode, and wherein communicating with the UE comprises at least one of: receiving, from the UE, a transmission of a PUSCH or PUCCH communication in a first set of repetition occasions using a first beam direction associated with a first unified TCI, of the pair of unified TCIs; or receiving, from the UE, a transmission of the PUSCH or PUCCH communication in a second set of repetition occasions using a second beam direction associated with a second unified TCI, of the pair of unified TCIs.

Aspect 23: The method of Aspect 21, wherein the configuration information indicates that a single frequency network (SFN) physical uplink shared channel (PUSCH) or physical uplink control channel (PUCCH) mode is configured for the UE, and wherein communicating with the UE comprises at least one of: receiving, from the UE, a first transmission of a PUSCH or PUCCH communication using a first beam direction associated with a first unified TCI of the pair of unified TCIs; or receiving, from the UE, a second transmission of the PUSCH or PUCCH communication, using a second beam direction associated with a second unified TCI of the pair of unified TCIs.

Aspect 24: The method of any of Aspects 21-23, wherein the list of configured reference signals includes a first list of sounding reference signals (SRSs) or SRS sets and a second list of SRSs or SRS sets, and wherein communicating with the UE comprises at least one of: receiving, from the UE, a first SRS or SRS set from the first list of SRSs or SRS sets using a first beam direction associated with a first unified TCI, of the pair of unified TCIs; or receiving, from the UE, a second SRS or SRS set from the second list of SRSs or SRS sets using a second beam direction associated with a second unified TCI, of the pair of unified TCIs.

Aspect 25: An apparatus for wireless communication at a device, comprising a processor; memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor; memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive configuration information associated with a single downlink control information (DCI) multiple transmit receive point (TRP) mode, wherein the configuration information indicates at least one of respective repetition modes for one or more physical channels or a list of configured reference signals;
receive an indication of a pair of unified transmission configuration indicators (TCIs); and
communicate with at least one of a first TRP or a second TRP using beam directions associated with the pair of unified TCIs based at least in part on the configuration information.

2. The UE of claim 1, wherein the one or more processors, to receive the indication of the pair of unified TCIs, are configured to:
receive a TCI codepoint that indicates a first unified TCI and a second unified TCI.

3. The UE of claim 1, wherein the pair of unified TCIs include a pair of joint downlink and uplink TCI indications or a pair of separate downlink TCI indications.

4. The UE of claim 3, wherein the configuration information indicates that a physical downlink control channel (PDCCH) repetition mode is configured for the UE, wherein the configuration information identifies a first control resource set (CORESET) list and a second CORESET list, and wherein the one or more processors, to communicate with at least one of the first TRP or the second TRP, are configured to:
receive at least one of:
a first transmission of a PDCCH communication, from the first TRP or the second TRP, in a first CORESET determined by applying a first unified TCI, of the pair of unified TCIs, to the first CORESET list, or
a second transmission of the PDCCH communication, from the first TRP or the second TRP, in a second CORESET determined by applying a second unified TCI, of the pair of unified TCIs, to the second CORESET list.

5. The UE of claim 3, wherein the configuration information indicates that a single frequency network (SFN) physical downlink control channel (PDCCH) mode is configured for the UE, wherein the configuration information identifies a control resource set (CORESET) list, and wherein the one or more processors, to communicate with at least one of the first TRP or the second TRP, are configured to
receive at least one of:
a first transmission of a PDCCH communication, from the first TRP, in a CORESET from the CORESET list using a first beam direction associated with a first unified TCI, of the pair of unified TCIs, or
a second transmission of the PDCCH communication, from the second TRP, in the CORESET from the CORESET list using a second beam direction associated with a second unified TCI, of the pair of unified TCIs.

6. The UE of claim 3, wherein the configuration information indicates that a physical downlink shared channel (PDSCH) repetition mode is an inter-slot time division multiplexed repetition mode, an intra-slot time division multiplexed repetition mode, a frequency division multiplexed repetition mode, or a space division multiplexed repetition mode, and wherein the one or more processors, to communicate with at least one of the first TRP or the second TRP, are configured to:
apply a first unified TCI, of the pair of unified TCIs, to a first set of repetition occasions associated with a PDSCH communication based at least in part on the PDSCH repetition mode; and
apply a second unified TCI, of the pair of unified TCIs, to a second set of repetition occasions associated with the PDSCH communication based at least in part on the PDSCH repetition mode.

7. The UE of claim 3, wherein the configuration information indicates that a single frequency network (SFN) physical downlink shared channel (PDSCH) mode is configured for the UE, and wherein the one or more processors, to communicate with at least one of the first TRP or the second TRP, are configured to:
receive at least one of:
a first transmission of a PDSCH communication, from the first TRP, using a first beam direction associated with a first unified TCI of the pair of unified TCIs, or
a second transmission of the PDSCH communication, from the second TRP, using a second beam direction associated with a second unified TCI of the pair of unified TCIs.

8. The UE of claim 3, wherein the list of configured reference signals includes a first list of channel state information reference signals (CSI-RSs) or CSI-RS sets and a second list of CSI-RSs or CSI-RS sets, and wherein the one or more processors, to communicate with at least one of the first TRP or the second TRP, are configured to:
receive, from the first TRP or the second TRP, a first CSI-RS or CSI-RS set identified by applying a first unified TCI, of the pair of unified TCIs, to the first list of CSI-RSs or CSI-RS sets; and
receive, from the first TRP or the second TRP, a second CSI-RS or CSI-RS set identified by applying a second unified TCI, of the pair of unified TCIs, to the second list of CSI-RSs or CSI-RS sets.

9. The UE of claim 1, wherein the pair of unified TCIs include a pair joint downlink and uplink TCI indications or a pair of separate uplink TCI indications.

10. The UE of claim 9, wherein the configuration information indicates that a physical uplink shared channel (PUSCH) or physical uplink control channel (PUCCH) repetition mode is an inter-slot time division multiplexed repetition mode, an intra-slot time division multiplexed repetition mode, a frequency division multiplexed repetition mode, or a space division multiplexed repetition mode, and wherein the one or more processors, to communicate with at least one of the first TRP or the second TRP, are configured to:
apply a first unified TCI, of the pair of unified TCIs, to a first set of repetition occasions associated with a PUSCH or PUCCH communication based at least in part on the PUSCH or PUCCH repetition mode; and
apply a second unified TCI, of the pair of unified TCIs, to a second set of repetition occasions associated with the PUSCH or PUCCH communication based at least in part on the PUSCH or PUCCH repetition mode.

11. The UE of claim 9, wherein the configuration information indicates that a single frequency network (SFN) physical uplink shared channel (PUSCH) or physical uplink control channel (PUCCH) mode is configured for the UE, and wherein the one or more processors, to communicate with at least one of the first TRP or the second TRP, are configured to:
transmit a first transmission of a PUSCH or PUCCH communication, to the first TRP, using a first beam direction associated with a first unified TCI of the pair of unified TCIs; and
transmit a second transmission of the PUSCH or PUCCH communication, to the second TRP, using a second beam direction associated with a second unified TCI of the pair of unified TCIs.

12. The UE of claim 9, wherein the list of configured reference signals includes a first list of sounding reference signals (SRSs) or SRS sets and a second list of SRSs or SRS sets, and wherein the one or more processors, to communicate with at least one of the first TRP or the second TRP, are configured to:
transmit a first SRS or SRS set identified by applying a first unified TCI, of the pair of unified TCIs, to the first list of SRSs or SRS sets; and
transmit a second SRS or SRS set identified by applying a second unified TCI, of the pair of unified TCIs, to the second list of SRSs or SRS sets.

13. A base station for wireless communication, comprising:
a memory; and
one or more processors, coupled to the memory, configured to:
transmit, to a user equipment (UE), configuration information associated with a single downlink control information (DCI) multiple transmit receive point (TRP) mode, wherein the configuration information indicates at least one of respective repetition modes for one or more physical channels or a list of configured reference signals;
transmit, to the UE, an indication of a pair of unified transmission configuration indicators (TCIs); and
communicate with the UE using at least one of a first beam direction associated with a first unified TCI of the pair of TCIs or a second beam direction associated with a second unified TCI of the pair of unified TCIs.

14. The base station of claim 13, wherein the one or more processors, to transmit the indication of the pair of unified TCIs, are configured to:
transmit, to the UE, a TCI codepoint that indicates a first unified TCI and a second unified TCI.

15. The base station of claim 13, wherein the pair of unified TCIs include a pair of joint downlink and uplink TCI indications or a pair of separate downlink TCI indications.

16. The base station of claim 15, wherein the configuration information indicates that a physical downlink control channel (PDCCH) repetition mode is configured for the UE, wherein the configuration information identifies a first control resource set (CORESET) list and a second CORESET list, and wherein the one or more processors, to communicate with the UE, are configured to:
transmit, to the UE, at least one of:
a first transmission of a PDCCH communication in a first CORESET from the first CORESET list using a first beam direction associated with a first unified TCI, of the pair of unified TCIs, or
a second transmission of the PDCCH communication in a second CORESET from the second CORESET list using a second beam direction associated with a second unified TCI, of the pair of unified TCIs, to the second CORESET list.

17. The base station of claim 15, wherein the configuration information indicates that a single frequency network (SFN) physical downlink control channel (PDCCH) mode is configured for the UE, wherein the configuration information identifies a control resource set (CORESET) list, and wherein the one or more processors, to communicate with the UE, are configured to:
transmit at least one of:
a first transmission of a PDCCH communication in a CORESET from the CORESET list using a first beam direction associated with a first unified TCI, of the pair of unified TCIs, or
a second transmission of the PDCCH communication in the CORESET from the CORESET list using a second beam direction associated with a second unified TCI, of the pair of unified TCIs.

18. The base station of claim 15, wherein the configuration information indicates that a physical downlink shared channel (PDSCH) repetition mode is an inter-slot time division multiplexed repetition mode, an intra-slot time division multiplexed repetition mode, a frequency division multiplexed repetition mode, or a space division multiplexed repetition mode, and wherein the one or more processors, to communicate with the UE, are configured to:
transmit, to the UE, a PDSCH communication in a first set of repetition occasions using a first beam direction associated with a first unified TCI, of the pair of unified TCIs; or
transmit, to the UE, the PDSCH communication in a second set of repetition occasions using a second beam direction associated with a second unified TCI, of the pair of unified TCIs.

19. The base station of claim 15, wherein the configuration information indicates that a single frequency network (SFN) physical downlink shared channel (PDSCH) mode is configured for the UE, and wherein the one or more processors, to communicate with the UE, are configured to:
a first transmission of a PDSCH communication using a first beam direction associated with a first unified TCI of the pair of unified TCIs, or
a second transmission of the PDSCH communication using a second beam direction associated with a second unified TCI of the pair of unified TCIs.

20. The base station of claim 15, wherein the list of configured reference signals includes a first list of channel state information reference signals (CSI-RSs) or CSI-RS sets and a second list of CSI-RSs or CSI-RS sets, and wherein the one or more processors, to communicate with the UE, are configured to:
transmit, to the UE, a first CSI-RS or CSI-RS set from the first list of CSI-RSs or CSI-RS sets using a first beam direction associated with a first unified TCI, of the pair of unified TCIs; or
transmit, to the LIE, a second CSI-RS or CSI-RS set from the second list of CSI-RSs or CSI-RS sets using a second beam direction associated with a second unified TCI, of the pair of unified TCIs.

21. The base station of claim 13, wherein the pair of unified TCIs include a pair joint downlink and uplink TCI indications or a pair of separate uplink TCI indications.

22. The base station of claim 21, wherein the configuration information indicates that a physical uplink shared channel (PUSCH) or physical uplink control channel (PUCCH) repetition mode is an inter-slot time division multiplexed repetition mode, an intra-slot time division multiplexed repetition mode, a frequency division multiplexed repetition mode, or a space division multiplexed repetition mode, and wherein the one or more processors, to communicate with the UE, are configured to:
receive, from the UE, a transmission of a PUSCH or PUCCH communication in a first set of repetition occasions using a first beam direction associated with a first unified TCI, of the pair of unified TCIs; or
receive, from the UE, a transmission of the PUSCH or PUCCH communication in a second set of repetition occasions using a second beam direction associated with a second unified TCI, of the pair of unified TCIs.

23. The base station of claim 21, wherein the configuration information indicates that a single frequency network (SFN) physical uplink shared channel (PUSCH) or physical uplink control channel (PUCCH) mode is configured for the UE, and wherein the one or more processors, to communicate with the UE, are configured to:
receive, from the LIE, a first transmission of a PUSCH or PUCCH communication using a first beam direction associated with a first unified TCI of the pair of unified TCIs; or
receive, from the UE, a second transmission of the PUSCH or PUCCH communication, using a second beam direction associated with a second unified TCI of the pair of unified TCIs.

24. The base station of claim 21, wherein the list of configured reference signals includes a first list of sounding reference signals (SRSs) or SRS sets and a second list of SRSs or SRS sets, and wherein the one or more processors, to communicate with the UE, are configured to:
receive, from the UE, a first SRS or SRS set from the first list of SRSs or SRS sets using a first beam direction associated with a first unified TCI, of the pair of unified TCIs; or
receive, from the UE, a second SRS or SRS set from the second list of SRSs or SRS sets using a second beam direction associated with a second unified TCI, of the pair of unified TCIs.

25. A method of wireless communication performed by a user equipment (UE), comprising:
receiving configuration information associated with a single downlink control information (DCI) multiple transmit receive point (TRP) mode, wherein the configuration information indicates at least one of respective repetition modes for one or more physical channels or a list of configured reference signals;
receiving an indication of a pair of unified transmission configuration indicators (TCIs); and
communicating with at least one of a first TRP or a second TRP using beam directions associated with the pair of unified TCIs based at least in part on the configuration information.

26. The method of claim 25, wherein receiving the indication of the pair of unified TCIs comprises:
receiving a TCI codepoint that indicates a first unified TCI and a second unified TCI.

27. The method of claim 25, wherein the pair of unified TCIs include a pair of joint downlink and uplink TCI indications or a pair of separate downlink TCI indications.

28. The method of claim 27, wherein the configuration information indicates that a physical downlink control channel (PDCCH) repetition mode is configured for the UE, wherein the configuration information identifies a first control resource set (CORESET) list and a second CORESET list, and wherein communicating with at least one of the first TRP or the second TRP comprises:
receiving at least one of:
a first transmission of a PDCCH communication, from the first TRP or the second TRP, in a first CORESET determined by applying a first unified TCI, of the pair of unified TCIs, to the first CORESET list, or
a second transmission of the PDCCH communication, from the first TRP or the second TRP, in a second CORESET determined by applying a second unified TCI, of the pair of unified TCIs, to the second CORESET list.

29. The method of claim 27, wherein the configuration information indicates that a single frequency network (SFN) physical downlink control channel (PDCCH) mode is configured for the UE, wherein the configuration information identifies a control resource set (CORESET) list, and wherein communicating with at least one of the first TRP or the second TRP comprises:
receiving at least one of:
a first transmission of a PDCCH communication, from the first TRP, in a CORESET from the CORESET list using a first beam direction associated with a first unified TCI, of the pair of unified TCIs, or
a second transmission of the PDCCH communication, from the second TRP, in the CORESET from the CORESET list using a second beam direction associated with a second unified TCI, of the pair of unified TCIs.

30. A method of wireless communication performed by a base station, comprising:
transmitting, to a user equipment (UE), configuration information associated with a single downlink control information (DCI) multiple transmit receive point (TRP) mode, wherein the configuration information indicates at least one of respective repetition modes for one or more physical channels or a list of configured reference signals;
transmitting, to the UE, an indication of a pair of unified transmission configuration indicators (TCIs); and
communicating with the UE using at least one of a first beam direction associated with a first unified TCI of the pair of TCs or a second beam direction associated with a second unified TCI of the pair of unified TCIs.
